(19) United States
(12) Patent Application Publication
(10) Pub. No.: US 2013/0346121 A1
(43) Pub. Date: Dec. 26, 2013

(54) SYSTEM AND METHOD FOR PARKING RESERVATION AND PAYMENT

(71) Applicant: WebPark, Inc., Atlanta, GA (US)

(72) Inventors: Cody William Shealy, Sharpsburg, GA (US); Steven David Taff, Douglasville, GA (US); Amanda Wallace Taff, Douglasville, GA (US); David Alan Klarman, Sandy Springs, GA (US); Richard Charles Graham, Powder Springs, GA (US); Karen Ann Kozireski-Quinn, Sharpsburg, GA (US); Marc Jastremski, Duluth, GA (US)

(73) Assignee: WebPark, Inc., Atlanta, GA (US)

(21) Appl. No.: 13/928,015

(22) Filed: Jun. 26, 2013

Related U.S. Application Data
(60) Provisional application No. 61/664,285, filed on Jun. 26, 2012.

(51) Int. Cl. G06Q 10/02

(52) U.S. Cl. CPC G06Q 10/02
USPC 705/5

(57) ABSTRACT

An exemplary embodiment includes a method for providing a parking reservation on a computer system. The parking reservation method is embodied in a computer program product for execution on an instruction processing system, comprising a tangible storage medium readable by the instruction processing system is storing instructions for execution by the instruction processing system. The method comprises enabling a customer to purchases a bar-coded pass online for an event, collecting payment for the bar-coded pass, and issuing the bar-coded pass to the customer. The method further comprises updating a current available parking slots inventory for a selected parking lot in the tangible storage medium, and validating the bar-coded pass by scanning the bar-coded pass to verify that the bar-coded pass is valid.

### CROSS-REFERENCE TO RELATED APPLICATION

This application claims the benefit of U.S. Provisional Patent Application 61/664,285, filed on Jun. 26, 2012, entitled “SYSTEM AND METHOD FOR PARKING RESERVATION AND PAYMENT”, which is incorporated by reference herein in its entirety.

### TECHNICAL FIELD

The present invention relates generally to the field of parking cars, and more particularly to managing prepayments for automobile parking.

### BACKGROUND OF THE INVENTION

Parking lots, outdoor arenas or other spaces are used for keeping vehicles in an ordered placement. Generally, however, these lots do not provide pre-purchase of a reservation.

It is to the provision of meeting this and other needs that the present invention is primarily directed.

### SUMMARY OF THE INVENTION

Embodiments of the present invention provide a system, method and computer program product for rating and selectively sharing venire members' and jurors' information including a plurality of jurors, where each juror is associated with a case and each case is associated with an entity.

An exemplary embodiment includes a method for providing a parking reservation on a computer system. The parking reservation method is embodied in a computer program product for execution on an instruction processing system, comprising a tangible storage medium readable by the instruction processing system is storing instructions for execution by the instruction processing system. The method comprises enabling a customer to purchases a bar-coded pass online for an event, collecting payment for the bar-coded pass, and issuing the bar-coded pass to the customer. The method further comprises updating a current available parking slots inventory for a selected parking lot in the tangible storage medium, and validating the bar-coded pass by scanning the bar-coded pass to verify that the bar-coded pass is valid.

Another exemplary embodiment includes a method for providing a long-term parking reservation on a computer system. The long-term parking reservation method is embodied in a computer program product for execution on an instruction processing system, comprising a tangible storage medium readable by the instruction processing system is storing instructions for execution by the instruction processing system. The method comprises determining a selected parking lot, determining the parking term period, and collecting payment for the long-term parking reservation. The method further comprises issuing a bar-coded pass for the long-term parking reservation to the customer if there is a slot space available in the selected parking lot and the payment is successful, and updating a current available parking slots inventory for a selected parking lot in the tangible storage medium if the bar-coded pass is issued to the customer.

A further exemplary embodiment includes a method for providing a remote validation of a bar-coded event pass on a computer system. The remote validation of a bar-coded event pass method is embodied in a computer program product for execution on an instruction processing system, comprising a tangible storage medium readable by the instruction processing system is storing instructions for execution by the instruction processing system. The method comprises scanning the bar-coded event pass with a scanner and determining if the bar-coded event pass is valid. The method further comprises permitting entry to a event if the bar-coded event pass is valid, and denying entry to the event if the bar-coded event pass is invalid.

A still further exemplary embodiment includes a method for issuing a citation to a parking violation of vehicle on a computer system. The issuing a citation to a parking violation of vehicle method is embodied in a computer program product for execution on an instruction processing system, comprising a tangible storage medium readable by the instruction processing system is storing instructions for execution by the instruction processing system. The method comprises scanning a bar-coded parking pass of the vehicle in question and inquiring if the vehicle has a history of parking violations. The method further comprises determining if the bar-coded parking pass is valid and issuing the citation if the bar-coded parking pass is invalid.

These and other aspects, features and advantages of the invention will be understood with reference to drawing figures and detailed descriptions herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWINGS

FIG. 1 is a block diagram illustrating an example of the network environment for the parking reservation services of the present invention.

FIG. 2 is a block diagram illustrating an example of a server utilizing the parking reservation services of the present invention, as shown in FIG. 1.

FIG. 3 is a flow chart illustrating an example of the operation of parking management system for the host of the present invention utilized by the server, as shown in FIGS. 2.

FIG. 4 is a flow chart illustrating an example of the operation of the customer configure process on the server that is utilized in parking management system of the present invention, as shown in FIGS. 2-3.

FIG. 5A is a flow chart illustrating an example of the operation of the customer purchase process on the server that is utilized in parking management system of the present invention, as shown in FIGS. 2-3.

FIG. 5B is a flow chart illustrating an example of the operation of the customer purchase parking transaction process on the server that is utilized in parking management system of the present invention, as shown in FIGS. 2-3 and 5A.

FIG. 6 is a flow chart illustrating an example of the operation of the long term process on the server that is utilized in parking management system of the present invention, as shown in FIGS. 2-3.

FIG. 7 is a flow chart illustrating an example of the operation of the parking event process on the server that is utilized in parking management system of the present invention, as shown in FIGS. 2-3.

FIG. 8 is a flow chart illustrating an example of the operation of the lot direction process on the server that is utilized in parking management system of the present invention, as shown in FIGS. 2-3.

FIG. 9 is a flow chart illustrating an example of the operation of the parking validation process on the server that is utilized in parking management system of the present invention, as shown in FIGS. 2-3.

FIG. 10 is a flow chart illustrating an example of the operation of the parking lot management process on the server that is utilized in parking management system of the present invention, as shown in FIGS. 2-3.

FIG. 11 is a flow chart illustrating an example of the operation of parking violations process on the server that is utilized in parking management system of the present invention, as shown in FIGS. 2-3.

FIG. 12 is a flow chart illustrating an example of the operation of the parking lot reports process on the server that is utilized in parking management system of the present invention, as shown in FIGS. 2-3.

FIG. 13 is a block diagram illustrating an example of a remote device utilizing the remote parking management system for the remote device of the present invention, as shown in FIG. 1.

FIG. 14 is a flow chart illustrating an example of the operation of the remote parking management system for the remote device of the present invention, as shown in FIG. 13.

FIG. 15 is a flow chart illustrating an example of the operation of the remote parking validation agent for the remote parking management system on the remote device of the present invention, as shown in FIGS. 13-14.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The difference between this system and that of the prior art is that the parking management system and method of the present invention enables a customer to purchase a parking reservation that is noted in a database in a server which communicates with the parking lot scanner in real time. In the prior art, they must take that information from their server and individually upload the info into each scanner. The parking management system and method of the present invention also offers the customer (person/entity contracting us to manage the parking) to log into in a database in a server (i.e. a website) and review in real time what is happening with the lot activity.

The invention described hereafter is applicable on all remote devices connected to a server hosting the parking management system and method of the present invention. While described below with respect to a single computer, the system and method for a webpage system is typically implemented in a networked computing environment in which a number of computing devices communicate over a local area network (LAN), over a wide area network (WAN), or over a combination of both LAN and WAN.

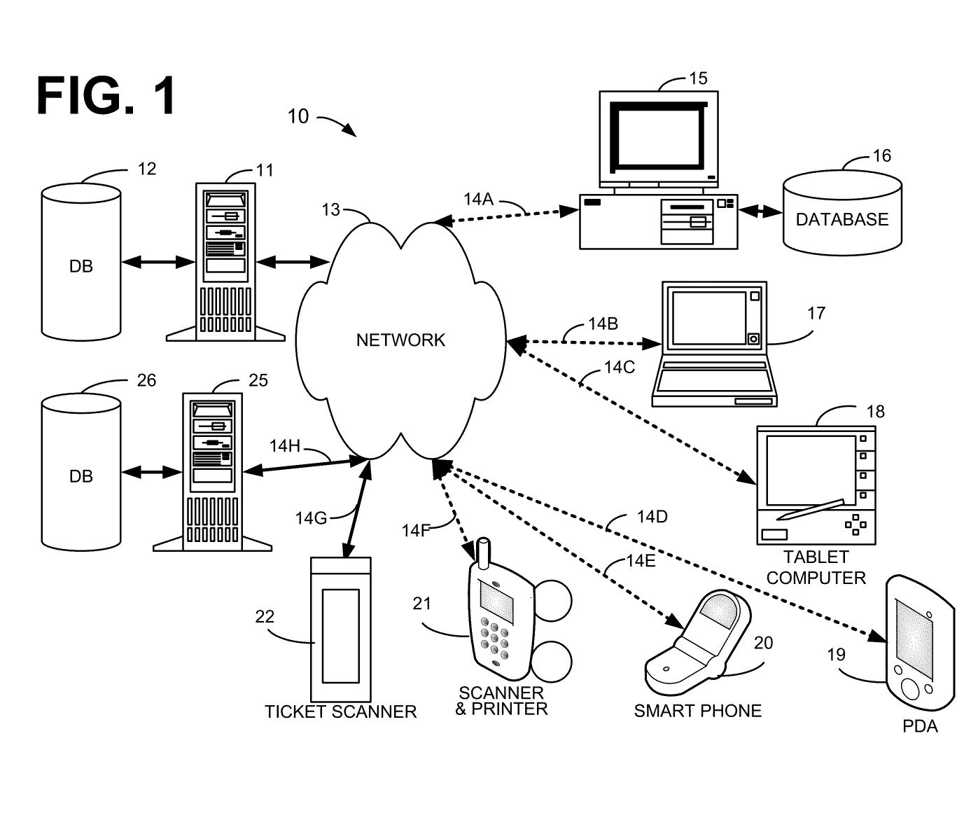

Referring now to the drawings, in which like numerals illustrate like elements throughout the several views. FIG. 1 illustrates an example of the basic components of a system 10 using the parking management system in connection with the preferred embodiment of the present invention. The system 10 includes a server 11 and the devices 15 and 17-22 that utilize parking management system of the present invention. The system 10 also includes a mobile scanner/printer 21 and a stand-alone scanner 22 for scanning bar-code passes. In the preferred embodiment, the bar-code passes are printed on paper. However, in alternative embodiments, the barcodes may be digitally stored on the device 17-20 that are then scanned by the mobile scanner/printer 21 and a stand-alone scanner 22 when the user customer arrives at the parking lot destination.

Each of the devices 15, 17-22 has applications and can have a local database 16. Server 11 contains applications, and a database 12 that can be accessed by devices 15 and 17-22 via connections 14(A-G), respectively, over network 13. The server 11 runs administrative software for a computer network and controls access to itself and database 12. The devices 15 and 17-22 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization (i.e. a hospital or medical complex).

The devices 15 and 17-22 may each be located at remote sites. Devices 15 and 17-22 include but are not limited to, PCs, workstations, laptops, handheld computers, smart phones, pocket PCs, PDAs, pagers, WAP devices, non-WAP devices, cell phones, palm devices, printing devices, mobile scanner/printer and a stand-alone scanner and the like. Included with each of the devices 15 and 17-22 is an ability to process a parking transaction on network 13. On the devices 15 and 17-20 there is a printer for printing out a bar-coded parking pass. In devices 15 and 17-22, there is the ability for displaying and/or scanning the barcode on a display screen.

Thus, when a user at one of the devices 15 and 17-20 desires to access prepay parking status from the database 12 at the server 11, the devices 15 and 17-22 communicate over the network 13, to access the server 11 and database 12. The mobile scanner/printer 21 and a stand-alone scanner 22 provide for an attendant or automated scanning of the bar-code parking passes using a detachable or fixed scanning module. The mobile scanner/printer 21 and a stand-alone scanner 22 may also provide for the remote purchase of bar-code parking passes and printing of the same.

Third party vendors computer systems 25 and databases 26 can be accessed by parking management system 100 on server 11 in order to process parking transactions for event providers wanting to provide integrated, event ticket purchasing along with prepaid parking reservations. Data that is obtained from third party vendors computer systems 25 and databases 26 can be stored on server 11 and database 12 in order to provide later access to the user on devices 15 and 17-22. It is also contemplated that for certain types of data that the devices 15 and 17-22 can access the third party vendors computer systems 25 and databases 26 directly using the network 13.

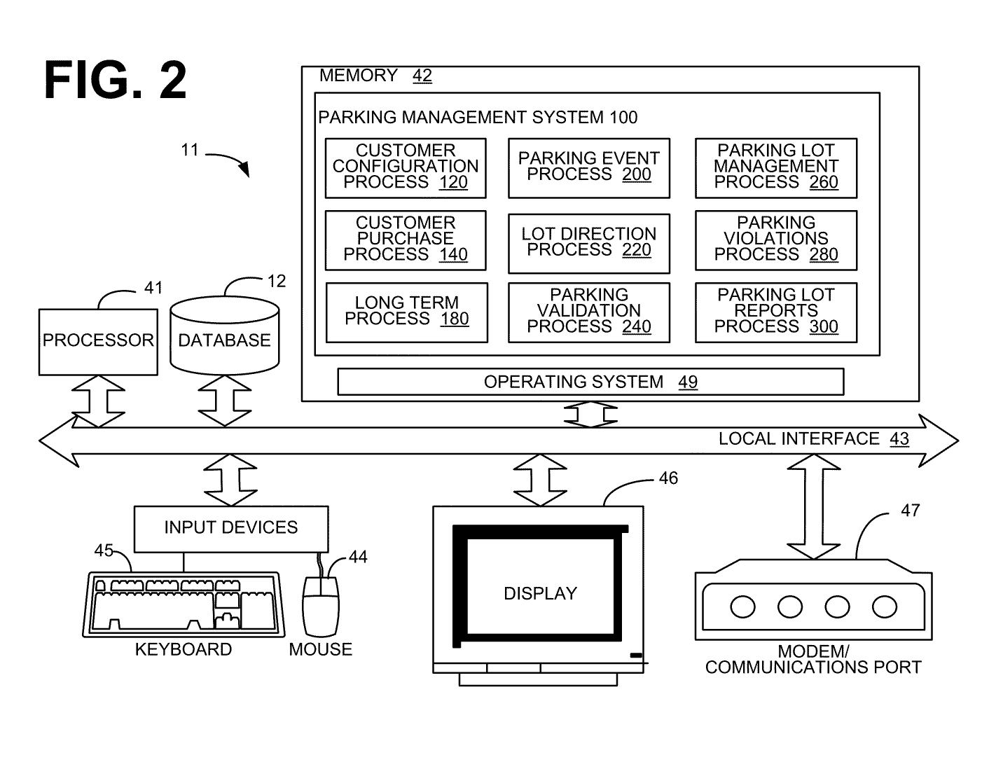

Illustrated in FIG. 2 is a block diagram demonstrating an example of server 11, as shown in FIG. 1, utilizing parking management system 100 of the present invention. Server 11 includes, but is not limited to, PCs, workstations, laptops, PDAs, palm devices and the like.

Generally, in terms of hardware architecture, as shown in FIG. 2, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2, the software in the memory 42 includes a suitable operating system (O/S) 49 and parking management system 100 of the present invention. As illustrated, parking management system 100 of the present invention comprises numerous functional components including, but not limited to, the customer configure process 120, customer purchase process 140, customer purchase parking transaction process 160, long-term process 180, parking event process 200, lot direction process 220, parking validation process 240, parking lot management process 260, parking violations process 280 and parking lot reports process 300.

A non-exhaustive list of examples of suitable commercially available operating systems 49 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 49 essentially controls the execution of other computer programs, such as parking management system 100, and provides scheduling, input-output control, file and data management, memory management, and communication control and related services. However, it is contemplated by the inventors that parking management system 100 of the present invention is applicable on all other commercially available operating systems.

Parking management system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, parking management system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, assembler, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and generally to control operations of the server 11 are pursuant to the software. Parking management system 100 and the O/S 49 are read, in whole or in part, by the processor 41, perhaps buffered within the processor 41, and then executed.

When parking management system 100 is implemented in software, as is shown in FIG. 2, it should be noted that parking management system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where parking management system 100 is implemented in hardware, parking management system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The remote devices 15 and 17-20 provides access to the parking management system 100 of the present invention on server 11 and database 12 using for example, but not limited to an Internet browser. The information accessed in server 11 and database 12 can be provided in the number of different forms including, but not limited to, ASCII data, WEB page data (i.e. HTML), XML or other type of formatted data.

As illustrated, the devices 15 and 17-20 are similar to the description of the components for server 11 described with regard to FIG. 2. Hereinafter, the devices 15 and 17-20 will be referred to as remote devices 15 for the sake of brevity.

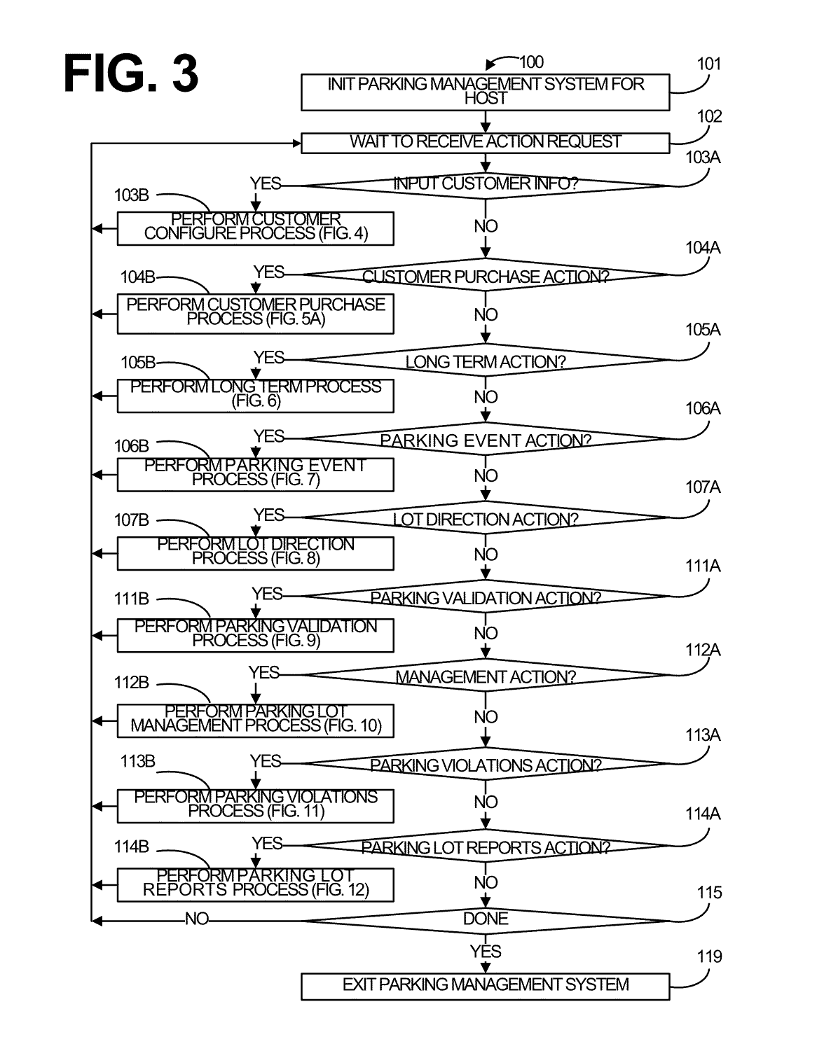

FIG. 3 is a flow chart illustrating an example of the operation of parking management system 100 of the present invention utilized by the server 11, as shown in FIG. 2. Parking management system 100 of the present invention provides a customer with the ability to purchase reservation that is noted in a database in a server which communicates with a parking lot scanner in real time. In the prior art, they must take that information from their server and individually upload the info into each scanner. The parking management system and method of the present invention also offers the customer (person/entity contracting us to manage the parking) to log into in a database in a server (i.e. a website) and review in real time what is happening with the lot activity.

First at step 101, parking management system 100 is initialized. This initialization includes the startup routines and processes embedded in the BIOS of the server 11. The initialization also includes the establishment of data values for particular data structures utilized in parking management system 100.

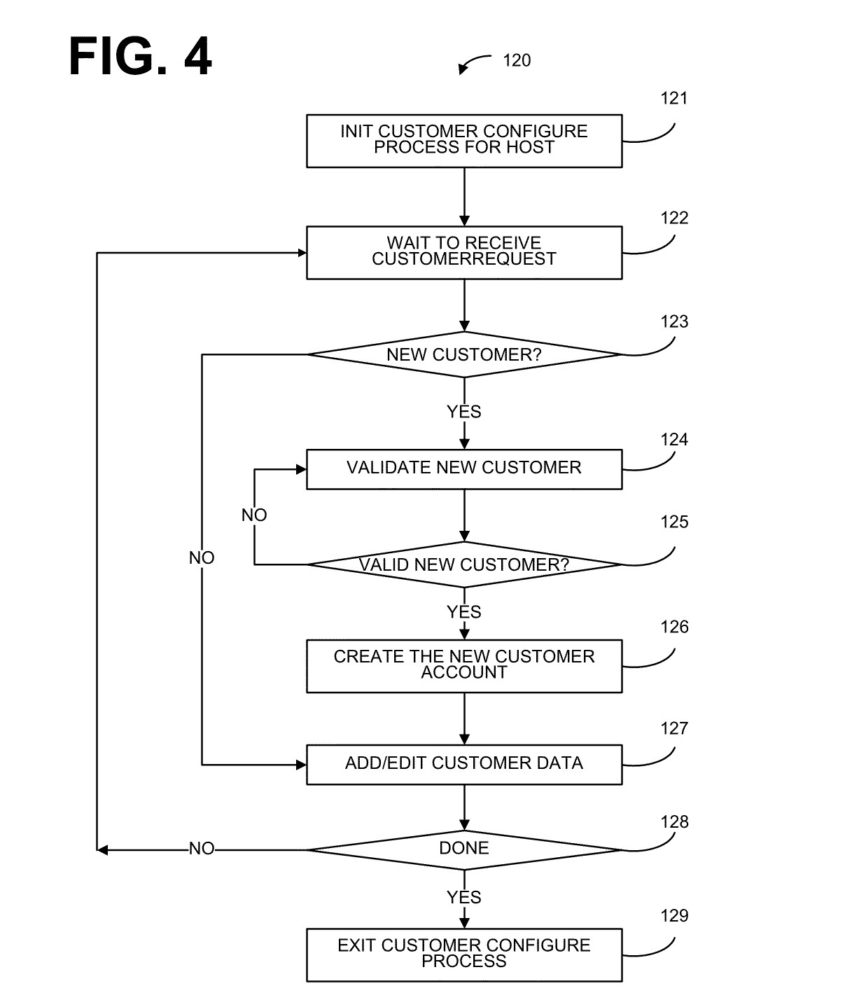

At step 102, parking management system 100 waits to receive an action request. Once an action is received at step 102, it is determined if the action is to input customer information to the service at step 103A. If it is determined that the action is not to input customer information to the service, then parking management system 100 skips to step 104A. However, if it is determined in step 103A that a new customer is to be added, then parking management system 100 performs the customer configure process at step 103B. The customer configure process is herein defined in further detail with regard to FIG. 4. After performing the customer configure process, the parking management system 100 returns to step 102.

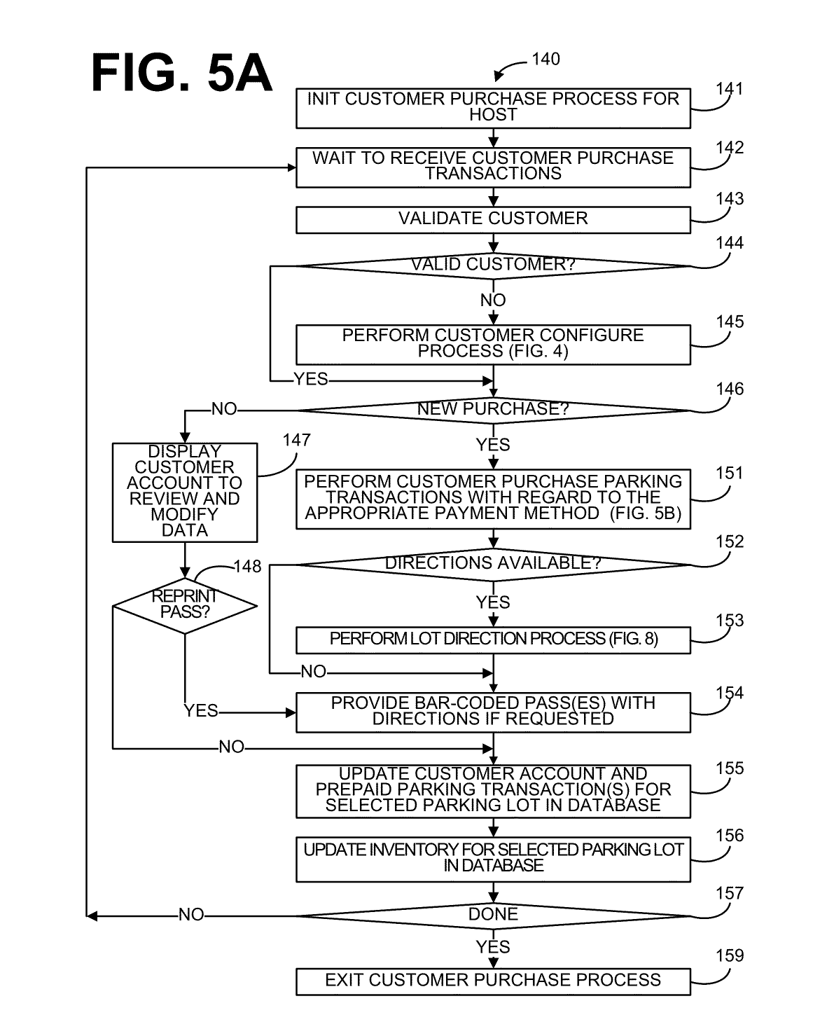

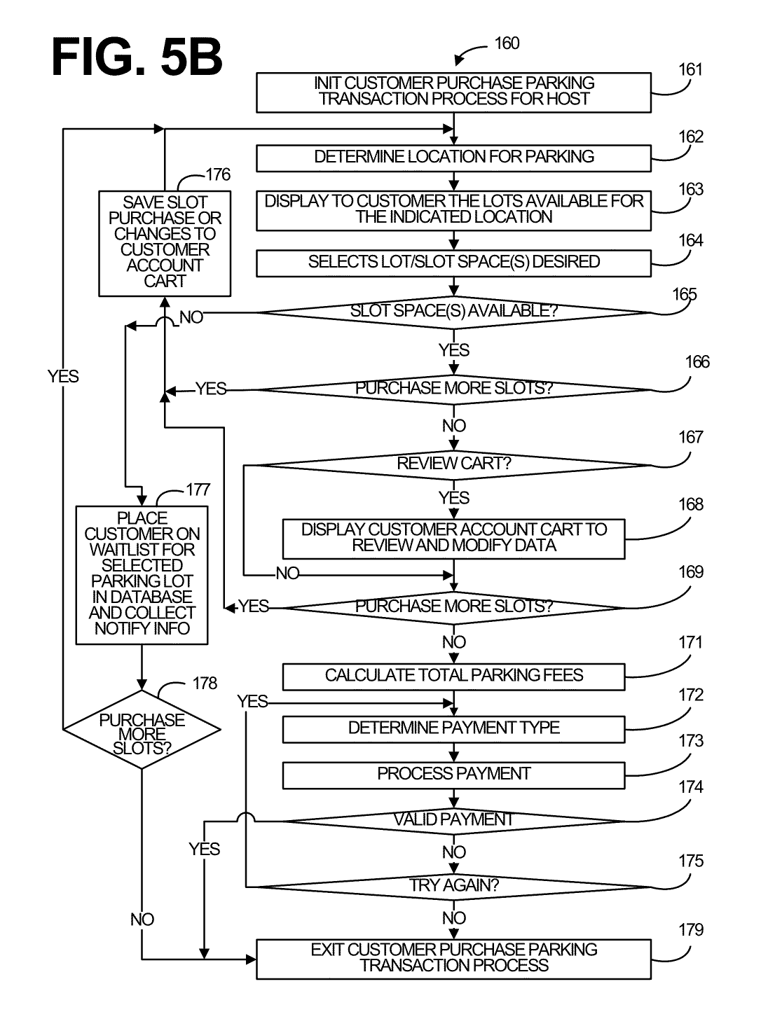

At step 104A, it is determined if the action is a customer purchase action. If it is determined that the action is not a customer purchase action, then parking management system 100 and step 105A. However, if it is determined in step 104A that it is a customer purchase action, then parking management system 100 performs the customer purchase process at step 105B. The customer purchase process is herein defined in further detail with regard to FIG. 5A. After performing the customer purchase process, the parking management system 100 returns to step 102.

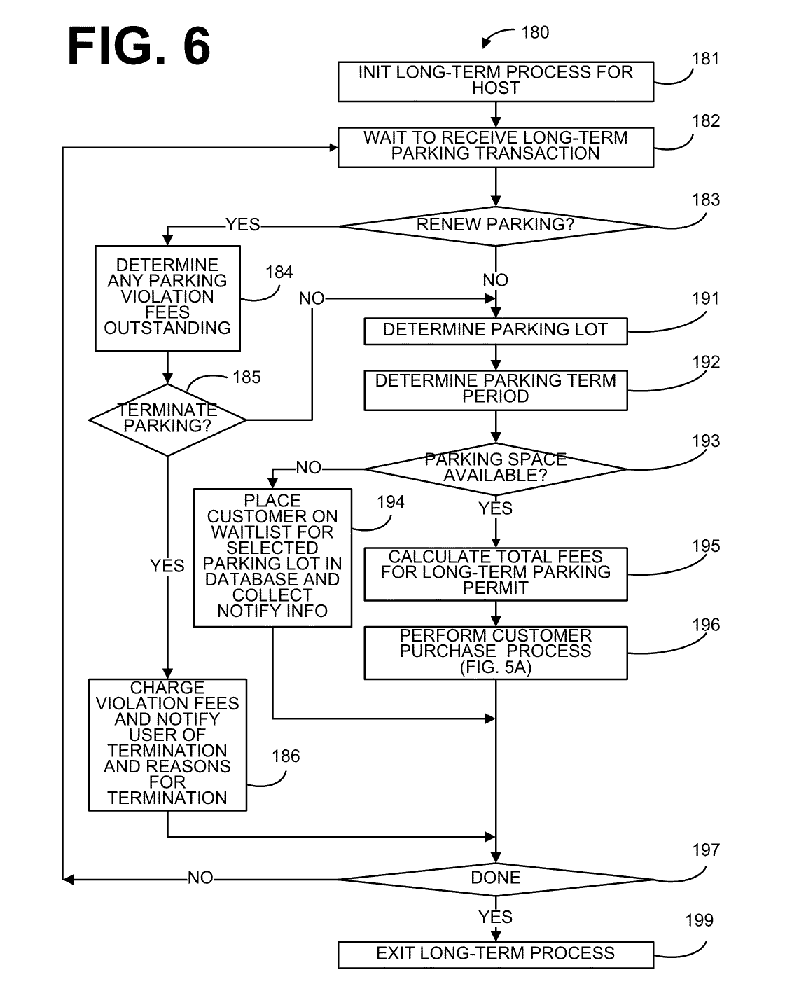

At step 105A, it is determined if the action is a long term action. If it is determined that the action is not a long term action, then parking management system 100 skips to step 106A. However, if it is determined in step 105A that it is a long term action, then parking management system 100 performs the long term process at step 105B. The customer purchase process is herein defined in further detail with regard to FIG. 6. After performing the long term process, the parking management system 100 returns to step 102.

At step 104A, it is determined if the action is a customer purchase action. In one embodiment, the customer purchase action is to purchase a parking pass for a single day. If it is determined that the action is not a customer purchase action, then parking management system 100 skips to step 105A. However, if it is determined in step 104A that it is a customer purchase action, then parking management system 100 performs the customer purchase process at step 104B. The customer purchase process is herein defined in further detail with regard to FIG. 5A. After performing the customer purchase process, the parking management system 100 returns to step 102.

At step 105A, it is determined if the action is a long term action. In one embodiment, a long-term action is a scenario in which the customer wishes to purchase a parking pass for more than one day. Examples include, but are not limited to parking passes in the customer is at work, apartment/condo, hotel, amusement park and the like. If it is determined that the action is not a long term action, then parking management system 100 skips to step 106A. However, if it is determined in step 105A that it is a long term action, then parking management system 100 performs the long term process at step 105B. The customer purchase process is herein defined in further detail with regard to FIG. 6. After performing the long term process, the parking management system 100 returns to step 102.

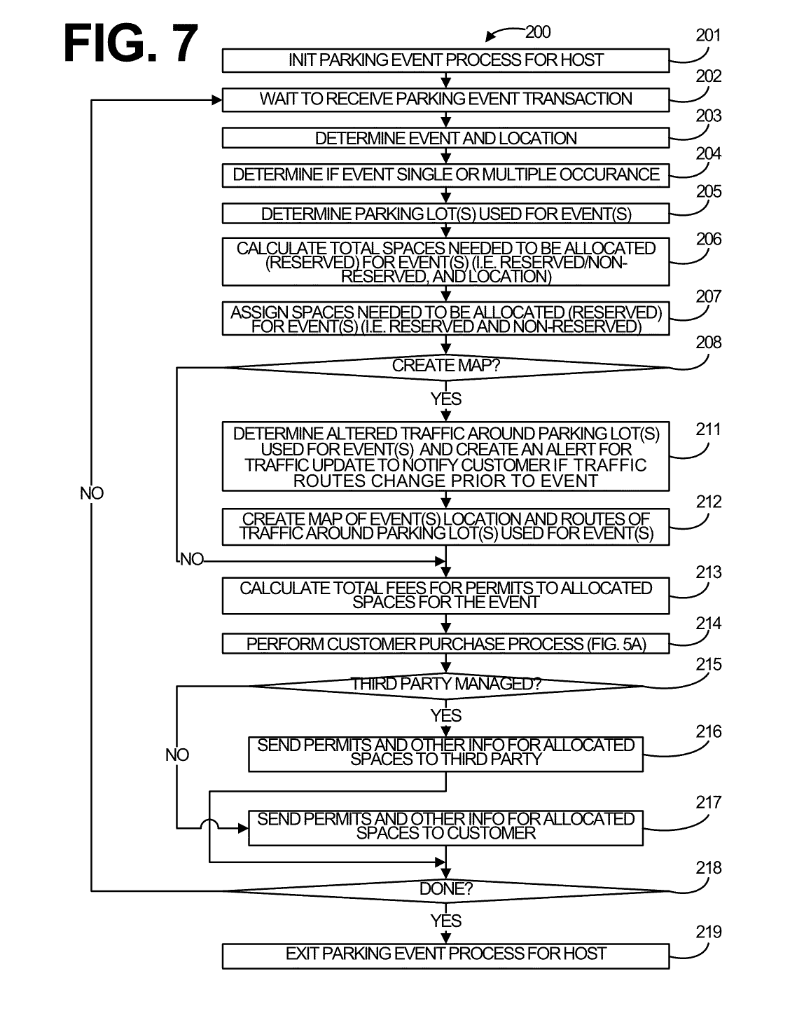

At step 106A, it is determined if the action is a parking event action. In one embodiment, a parking event enables a customer to reserve one or more parking spots at an event. The events occurring include, but are not limited to a sporting event (i.e. pro, college, high school or the like), cultural event (i.e. a concert, theater, amusement event or the like), or the like. In one embodiment, the customer may purchase parking passes for one or multiple occurrences for one or multiple cars or a third party may manage to spots. If it is determined that the action is not a parking event action, then parking management system 100 skips to step 107A. However, if it is determined in step 106A that it is a parking event action, then parking management system 100 performs the parking event process at step 106B. The parking event process is herein defined in further detail with regard to FIG. 7. After performing the parking event process, the parking management system 100 returns to step 102.

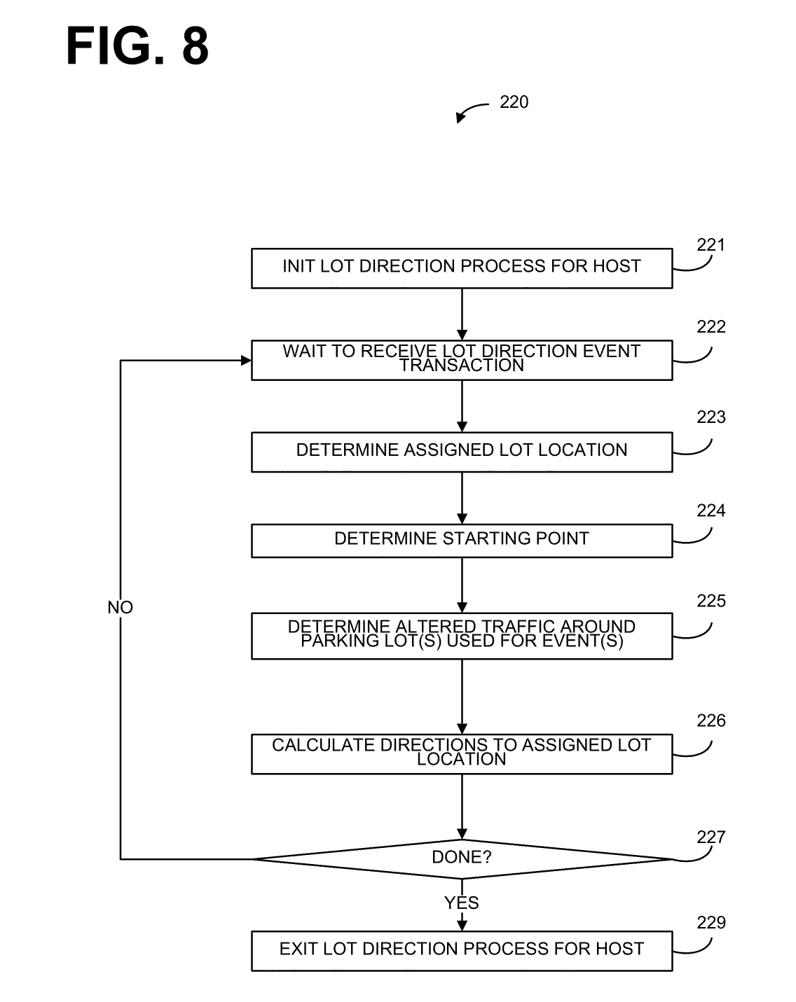

At step 107A, it is determined if the action is a lot direction action. In one embodiment, a lot direction action enables the customer to acquire directions from their starting point to the assigned lot location. In an alternative embodiment, the lot direction action determines if alternate roads are to be used because the traffic pattern to the assigned lot location has been altered because of an event. If it is determined that the action is not a lot direction action, then parking management system 100 skips to step 111A. However, if it is determined in step 107A that it is a lot direction action, then parking management system 100 performs the lot direction process at step 107B. The lot direction process is herein defined in further detail with regard to FIG. 8. After performing the lot direction process, the parking management system 100 returns to step 102.

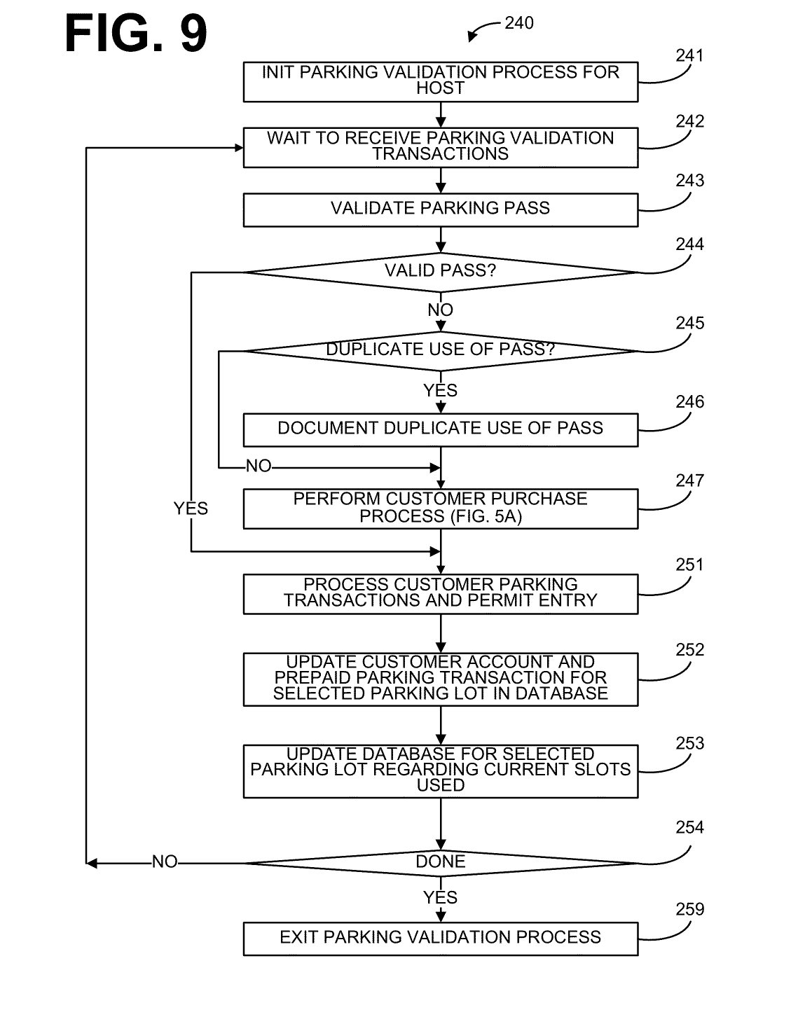

At step 111A, it is determined if the action is a parking validation action. In one embodiment, a parking validation action occurs at the entrance of a parking lot by scanning the parking pass. If it is determined that the action is not a parking validation action, then parking management system 100 skips to step 112A. However, if it is determined in step 111A that it is a parking validation action, then parking management system 100 performs the parking validation process at step 111B. The parking validation process is herein defined in further detail with regard to FIG. 9. After performing the parking validation process, the parking management system 100 returns to step 102.

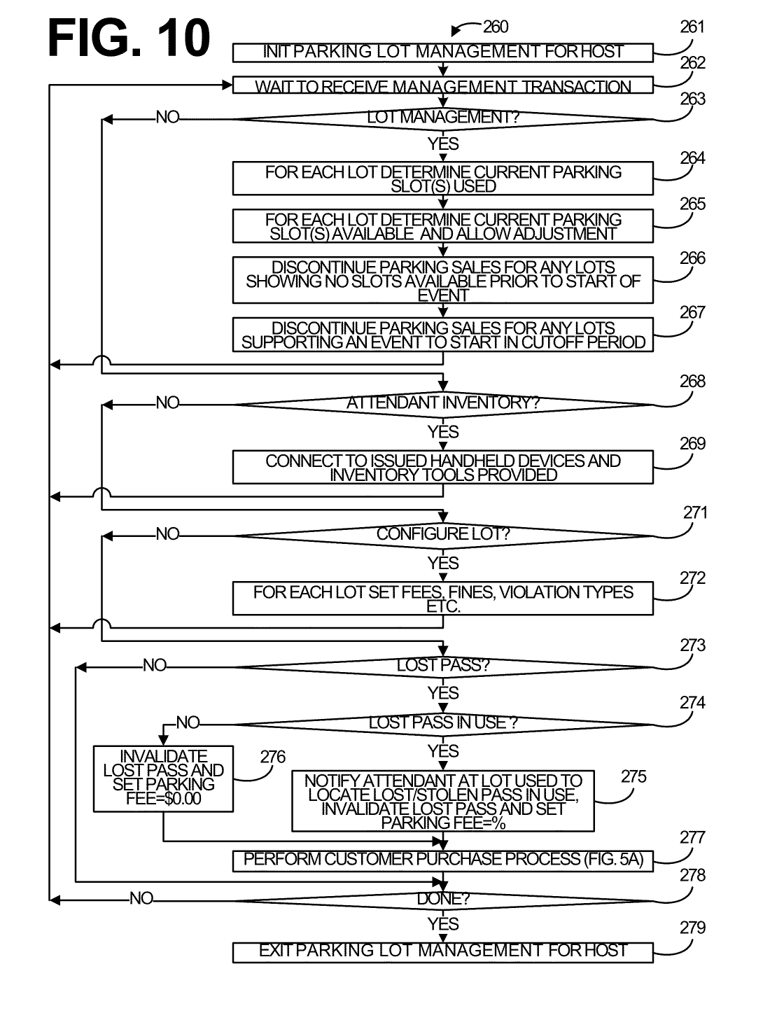

At step 112A, it is determined if the action is a management action. In one embodiment, a parking lot management action enables management to determine inventory (i.e., current parking slots used and available), configure a parking lot and process any lost passes that it might be discovered in use and the like. If it is determined that the action is not a management action, then parking management system 100 skips a to step 113A. However, if it is determined in step 112 that it is a management action, then parking management system 100 performs the parking lot management process at step 112B. The parking lot management process is herein defined in further detail with regard to FIG. 10. After performing the parking lot management process, the parking management system 100 returns to step 102.

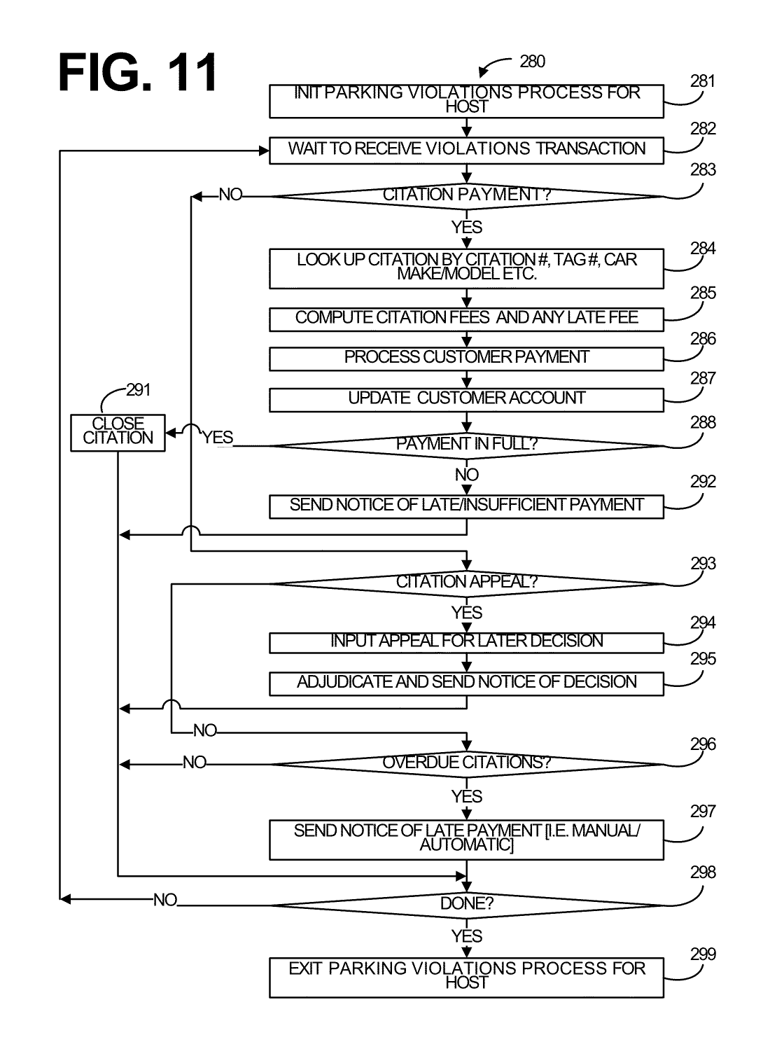

At step 113A, it is determined if the action is a parking violations action. In one embodiment, a parking violations action enables a customer to make a payment with regard to a citation or appeal a citation. In an alternative embodiment, the parking violations action enables management to determine is issued citations are overdue and manually/automatically send notices of late payments to the recipients of the citations. If it is determined that the action is not a parking violations action, then parking management system 100 skips to step 114A. However, if it is determined in step 113A that it is a parking violations action, then parking management system 100 performs the parking violations process at step 113B. The parking violations process is herein defined in further detail with regard to FIG. 11. After performing the parking violations process, the parking management system 100 returns to step 102.

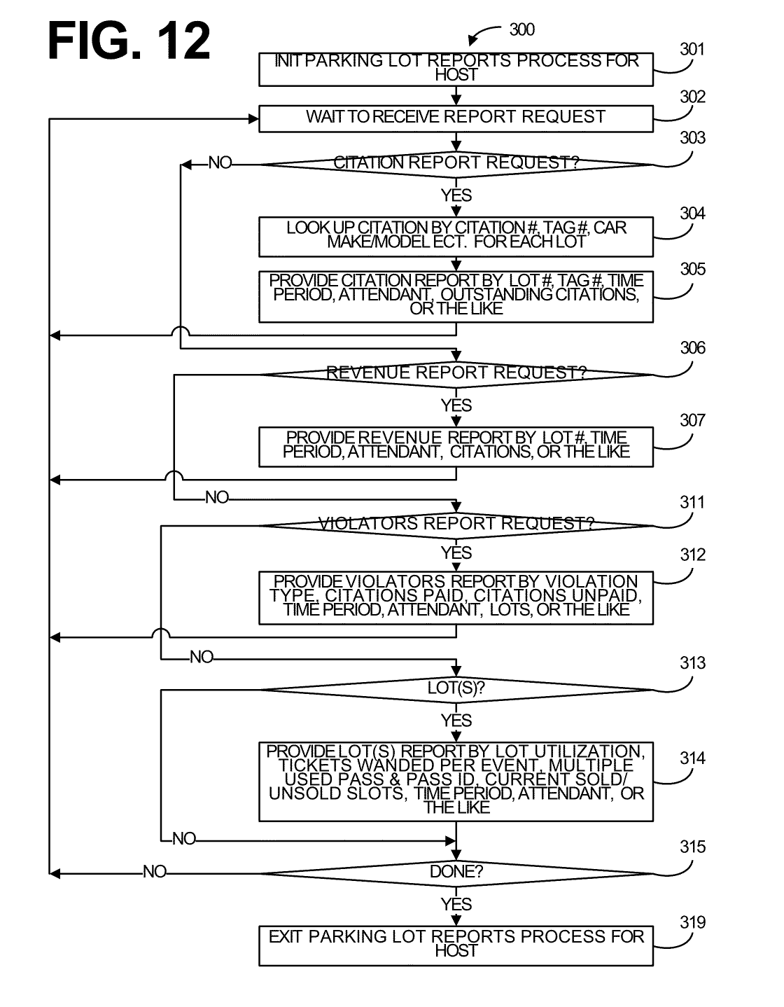

At step 114A, it is determined if the action is a parking lot report action. In one embodiment, a parking lot report action enables management to receive reports with regard to citations, revenue, violators, status of parking lots, and the like. If it is determined that the action is not a parking lot report action, then parking management system 100 skips to step 115. However, if it is determined in step 114A that it is a parking lot report action, then parking management system 100 performs the parking lot report process at step 114B. The parking lot report process is herein defined in further detail with regard to FIG. 12. After performing the parking lot report process, the parking management system 100 returns to step 102.

At step 115, it is determined if parking management system 100 is to wait for additional action request. If it is determined at step 115 that parking management system is to wait to receive additional actions, then parking management system 100 returns to repeat steps 102 through 115. However, if it is determined at step 115 that there are no more actions to be received, then parking management system 100 then exits at step 119.

FIG. 4 is a flow chart illustrating an example of the operation of the customer configure process 120 on the server that is utilized in parking management system 100 of the present invention, as shown in FIGS. 2-3. The customer configure process 120 can establish or modify customer specific information residing on database 12 (FIG. 2). Once the new customer information is placed in server 11, it is available for customer parking reservations. A brief overview of one exemplary process is as follows: 1) waits to receive a customer configure request; 2) determine if the customer is a new customer; 3) Validate and store new customer name; 4) upload new /modify existing customer information from local machine; and 5) done.

First at step 121, the customer configure process 120 is initialized. This initialization includes the startup routines and processes embedded in the BIOS of the server 11. The initialization also includes the establishment of data values for particular data structures utilized in the customer configure process 120.

At step 122, the customer configure process 120 waits to receive a new customer request. Once a new customer request has been received, the customer configure process 120 determines if the customer is a new customer to parking management system 100. If it is determined at step 123 that the customer is not a new customer, then the customer configure process 120 skip step 127 to enable the customer to enter new or edit existing customer data. However, if it is determined at step 123 that the customer is a new customer, then the customer configure process 120 validates the new customer at step 124. The new customer is registered at this time and is validated against information in database 12 at step 125. This information may include validating the customer payment method. If the new customer is not valid, then the customer configure process 120 returns to step 124. However, if the new customer is valid, then the customer configure process 120 enables the new customer to create a new customer account at step 126.

At step 127, the customer configure process 120 enables the customer to add or edit existing customer data in the new customer account.

At step 128, it is determined if the customer configure process 120 is to wait for additional customer requests. If it is determined at step 128 that the customer configure process 120 is to wait for additional customer requests, then the customer configure process 120 returns to repeat steps 122 through 128. However, if it is determined at step 128 that there are no more customer actions to be received, then the customer configure process 120 then exits at step 129.

FIG. 5A is a flow chart illustrating an example of the operation of the customer purchase process 140 on the server that is utilized in parking management system 100 of the present invention, as shown in FIGS. 2-3. Once the new customer is placed in server 11, it is available for reservation transaction to occur. A brief overview of one exemplary process is as follows: 1) determine if a customer account established and establishing the customer if not; 2) acquire customer reservation data; 3) determine if directions to parking lot were requested and providing them if so; 4) provide bar-coded pass with directions if requested; 5) update customer account in prepaid parking transaction information and 6) done.

First at step 141, the customer purchase process 140 is initialized. This initialization includes the startup routines and processes embedded in the BIOS of the server 11. The initialization also includes the establishment of data values for particular data structures utilized in the customer purchase process 140.

At step 142, the customer purchase process 140 waits to receive a customer reservation transaction. Once a customer reservation transaction has been received, the customer purchase process 140 then validates that the customer account exists at step 143. At step 144, the customer purchase process 140 determines if the customer is a current customer. If the customer account exists, then the customer purchase process 140 skip step 146. However, if a customer account does not exist for the new customer, the customer configure process 120 is performed at step 145.

At step 146, it is determined if the customer purchase transaction is a new purchase. If it is determined that the customer purchase transaction is a new purchase, then the customer purchase process 140 skip to step 151. However, it is determined that the customer purchase transaction is not a new purchase, then the customer purchase process 140 displays the customer account information for review and modification of the data at step 147. At step 148, it is determined if the parking pass is to be reprinted. If it is determined at step 148 that the parking pass is to be reprinted, then the customer purchase process 140 proceeds to step 154. However, if it is determined at step 148 that the customer purchase transaction is not to reprint the pass, then the customer purchase process 140 proceeds to step 155.

At step 151, the customer purchase parking transactions is processed with regard to the appropriate payment method. The customer purchase parking transactions is herein defined in further detail with regard to FIG. 5B. After performing the customer purchase parking transactions, the customer purchase process 140 then determines if directions were requested at step 152. If it is determined that directions were not requested, then the customer purchase process 140 skip to step 154. However, if it is determined at step 152 that directions were requested, then the customer purchase process 140 performs the lot direction process at step 153. The lot direction process is herein defined in further detail with regard to FIG. 8.

At step 154, the customer purchase process 140 provides the customer with a barcode pass. In a preferred embodiment, this bar code pass it is printed. However, in alternative embodiments, this barcode pass can be an image that is sent to the remote devices 15 for further presentation upon arriving at the preferred parking lot. At step 155, the customer purchase process 140 updates the customer account and the pre-parking transaction for the selected parking lot in database 12. At step 156, the inventory is updated for the selected parking lot in database 12.

At step 157, it is determined if the customer purchase process 140 is to wait for additional customer transactions. If it is determined at step 157 that the customer purchase process 140 is to wait for additional customer transactions, then the customer purchase process 140 returns to repeat steps 142 through 157. However, if it is determined at step 157 that there are no more customer transactions to be received, then the customer purchase process 140 then exits at step 159.

FIG. 5B is a flow chart illustrating an example of the operation of the customer purchase parking transaction process 160 on the server 11 that is utilized in customer purchase process 140, as shown in FIGS. 3 and 5A. Once a customer purchase process 140 commences, it is the customer purchase parking transaction process 160 that processes the parking transaction. A brief overview of one exemplary process is as follows: 1) determines the location for parking; 2) displays parking lots available at the location and let customer select lot/slots spaces desired; 3) determining if the number of slots spaces desired are available at the parking lot selected by the customer; 4) placing customer on a wait list if the slots spaces desired are not available; 5) if slot spaces desired are available then determine if the customer wishes to purchase additional slot(s); 6) saving the slot purchase or changes to a customer account cart if the customer wishes to purchase additional slot(s) and returned to step 1; 7) display customer account cart if the customer wants to review their cart; 8) determine if the customer wishes to purchase additional slot(s); 9) saving the slot purchase or changes to a customer account cart if the customer wishes to purchase additional slot(s) and returned to step 1; 10) calculating the total parking fees; 11) determine payment type and process payment; 12) determining if the payment was valid and trying again if invalid; and 13) exit.

First at step 161, the customer purchase parking transaction process 160 is initialized. This initialization includes the startup routines and processes embedded in the BIOS of the server 11. The initialization also includes the establishment of data values for particular data structures utilized in the customer purchase parking transaction process 160.

At step 162, the customer purchase parking transaction process 160 determines the location for parking. The location can be determined by a variety of methods including but not limited to, indicated city and state, street addresses, zip codes, events, and the like. At step 163, the customer purchase parking transaction process 160 displays parking lots available at the location to the customer. In one embodiment, this can be only the parking lots managed by the operator of the parking management system 100. In an alternative embodiment, the parking lots displayed can be all available parking lots. At step 164, data is received from the customer regarding the lot and slot space(s) desired.

At step 165, it is determined that there are slot space(s) available at the selected parking lot. If it is determined, at step 165, that there are not slot space(s) available at the parking lot selected by the customer, then the customer purchase parking transaction process 160 to step 177. However, if it is determined, at step 165, that there are slot space(s) available at the parking lot selected by the customer, then it is determined if the customer wishes to purchase additional slot(s) at step 166. If it is determined that the customer does wish to purchase more slot spaces, then the customer purchase parking transaction process 160 proceeds to step 176 to save the slot purchase or changes to a customer account cart. Customer purchase parking transaction process 160 then returns to step 162. If it is determined that the customer does not wish to purchase more slot spaces, then it is determined if the customer wants to review their cart at step 167. If it is determined at step 167 that the customer does not wish to review their cart, then the customer purchase parking transaction process 160 proceeds to step 169. However, if it is determined at step 167 that the customer does wish to review the items in their customer account cart, then the customer account cart is displayed to the customer at step 168. At this time, the customer can review and modify the data in their customer account cart.

At step 169, it is determined if the customer wishes to purchase additional slot spaces. If it is determined that the customer does wish to purchase more slot spaces, then the customer purchase parking transaction process 160 proceeds to step 176 to save the slot purchase or changes to a customer account cart. Customer purchase parking transaction process 160 then returns to step 162. If it is determined that the customer does not wish to purchase more slot spaces, then the customer purchase parking transaction process 160 calculates the parking fees for the reserve slot spaces, at step 171. At step 172, the payment type is determined. At step 173, the customer purchase parking transaction process 160 processes that payment.

At step 174, it is determined if the payment was valid. If the payment is valid, then the customer purchase parking transaction process 160 skips to step 179. However, if the payment was not valid, then it is determined if the customer purchase parking transaction process 160 is to try again at step 175. If it is determined that the payment is not to be attempted again, then the customer purchase parking transaction process then exits at step 179. However, if it is determined in step 175 that the payment is to be reattempted, then the customer purchase parking transaction process 160 returns to repeat steps 172 through 175.

At step 177, the customer notification data is collected, and the customer is placed on a wait list. The customer purchase parking transaction process 160 then determines if the customer wishes to purchase more slots spaces at step 178. If it is determined at step 178 that the user does wish to purchase more slots, spaces, then the customer purchase parking transaction process 160 returns to repeat steps 162-178. However, if it is determined at step 178 that the customer does not wish to purchase more slots spaces, then the customer purchase parking transaction process 160 proceeds to step 179.

At step 179, the customer purchase parking transaction process 160 exits and returns control to step 146 in FIG. 5A.

FIG. 6 is a flow chart illustrating an example of the operation of the long-term process 180 on the server 11 that is utilized in parking management system 100 of the present invention, as shown in FIGS. 2-3. The long-term process 180 is used to purchase a parking pass for a multiple days. In one embodiment, a long-term action is a scenario in which the customer wishes to purchase a parking pass for more than one day. Examples include, but are not limited to parking passes for parking when the customer is at work, apartment/condo, hotel, amusement park and the like. A brief overview of one exemplary process is as follows: 1) determine if the long-term action is for renewing an existing customer parking engagement; 2) if renewing a parking engagement, then determine if there are any parking violation fees outstanding that would cause termination of the parking engagement; 3) determine the violation fees and notify user of parking engagement termination if parking is to be terminated; 4) if renewing parking is available or acquiring a new long term parking engagement, then determine the lot and parking term for the parking engagement; 5) determining if a parking slot space is available; 6) calculating total fees for long-term parking permit and performing the customer purchase process, if a parking slot space is available; 7) placing the customer on a wait list if a parking slot space is not available and notifying the customer of the same; and 8) determining if the customer wishes to purchase additional parking spaces.

First at step 181, the long-term process 180 is initialized. This initialization includes the startup routines and processes embedded in the BIOS of the server 11. The initialization also includes the establishment of data values for particular data structures utilized in the long-term process 180.

At step 182, the long-term process 180 waits to receive a long-term parking transaction. Once a long-term parking transaction has been received, the long-term process 180 then determines if the long-term action is for renewing an existing customer parking engagement at step 183. If the customer account does not exist, then the long-term process 180 skips to step 191. However, if a customer account does exist for the customer, then the long-term process 180 determines if there are any parking violation fees outstanding, at step 184. At step 185, the long-term process 180 determines if any outstanding violations would be numerous enough or are serious enough to cause termination of the parking engagement. If it is determined at step 185 that the outstanding violations would be numerous enough or were serious enough to cause termination, then the long-term process 180 charges the customer the violation fees and notifies the customer of the parking engagement termination. The long-term process 180 then proceeds to step 197.

At step 191, the long-term process 180 determines the lot the customer is to use. At step 192, the parking term for the parking engagement is determined. At step 193, the long-term process 180 determines if a parking slot space is available. If it is determined that a parking slot space in the indicated parking lot is available, then the long-term process 180 skips to step 195. However, it is determined at step 193 that a parking slot space is not available in the determined parking lot, then the long-term process 180 places the customer on a wait list for the selected parking lot in the database 12 and collects notification information, at step 194. The long-term process 180 then skips to step 197.

At step 195, a long-term process 180 calculates the total fees for long-term parking permit. At step 196, the customer purchase process 140 is performed to complete the customer purchase transaction.

At step 197, long-term process 180 determines if the customer wishes to purchase additional long-term parking spaces. If it is determined at step 197 that the customer wishes to purchase additional long-term parking spaces, then the long-term process 180 returns to repeat steps 182 through 197. However, if it is determined at step 197 that the customer does not want to purchase additional long-term parking spaces, then the long-term process 180 then exits at step 199.

FIG. 7 is a flow chart illustrating an example of the operation of the parking event process 200 on the server 11 that is utilized in parking management system 100 of the present invention, as shown in FIGS. 2-3. In one embodiment, a parking event enables a customer to reserve one or more parking spots at an event. The events occurring include, but are not limited to a sporting event (i.e. pro, college or the like), cultural event (i.e. a concert, theater, amusement event or the like), or the light. In one embodiment, the customer may purchase parking passes for one or multiple occurrences for one or multiple cars or a third party may manage to spots. A brief overview of one exemplary process is as follows: 1) determine the event and its location; 2) determine if the event is for a single or multiple occurrence (i.e. consecutive or non-consecutive days); 3) determine the parking lot(s) used for the event; 4) calculate total spaces needed to be allocated; 5) assign parking spaces needed to be allocated for the event (i.e. reserved and non-reserved); 6) determine if a map to be provided with the parking passes; 7) calculate total fees for the parking permits to be purchased; 8) perform the customer purchase process; 9) determine if the parking permits are going to be managed by a third party, and send the permits and other info for the allocated spaces to the third-party; 10) for spaces not managed by a third party, send the permits and other information to the to the customer; and 11) determine if more spaces are to be purchased for an event.

First at step 201, the parking event process 200 is initialized. This initialization includes the startup routines and processes embedded in the BIOS of the server 11. The initialization also includes the establishment of data values for particular data structures utilized in the parking event process 200.

At step 202, the parking event process 200 waits to receive a pay parking event transaction. Once receiving a parking event transaction, the parking event process 200 determines the event and its location, at step 203. At step 204, it is determined if the event is for a single or multiple occurrence (i.e. consecutive or non-consecutive days. Once the event, location and number of parking passes needed by the customer, the parking event process 200 then determines which parking lot or lots can be used to support the event at step 205. In cases where an event is held in a large city, there may be any number of parking lots used to support the parking requirements of the event. At step 206, the parking event process 200 calculates the total number of spaces needed to be allocated to the customer for the event. At step 207, the parking event process 200 assigns the parking spaces needed to be allocated for the event (i.e. reserved and non-reserved).

At step 208, it is determined if the parking event process 200 is to create a map of the streets surrounding the assigned parking lot and event. If it is determined at step 208 that a map is not to be created, then the parking event process 200 skips to step 213. However, if it is determined that a map is to be created, then the parking event process 200 determines if there is planned to any altered traffic around the parking lot or lots used for the event, at step 211. It is quite normal that when a large event is held, that streets may be temporarily closed or converted into one-way traffic in and out of the event. In an alternative embodiment, an alert is created to monitor for updates to altered traffic patterns around the parking lot. If the alert is created, the customer is notified of all update to altered traffic patterns as they occur. This information can be delivered via e-mail, Twitter, automated phone calls, and the like. The customer indicates the preferred and alternative method of receiving this information when customer data is captured at step 127 (FIG. 4). The customer may indicate at step 127 the time period ranges for which this updated information is provided to the customer. For example only, a customer may indicate that they only wish to receive this information any time prior to the event occurring, any time the day of the event or just six hours prior and two hours after the event. At step 212, the parking event process 200 creates a map of the event location and routes of traffic around the parking lot used for the event.

At step 213, the parking event process 200 calculates the total fees for the allocated parking permits. At step 214, the customer purchase process 140 is performed to purchase of the parking permits for the allocated spaces.

At step 215, it is determined if a third party is managing the allocated parking spaces for the event. If it is determined at step 215 that a third party is not managing parking space permits allocated, then the parking event process 200 skips to step 217. However, it is determined in step 215 that a third party is managing parking space permits allocated then the parking event process 200 sends the permits and other info for the allocated spaces to the third-party, at step 216. The parking event process 200 then skips to step 218.

At step 217, the parking event process 200 sends the permits and other info for the allocated spaces to the customer.

At 218, the parking event process 200 determines if more parking spaces for an event are to be purchased by this customer. If it is determined at step 218 that the customer wishes to purchase additional parking spaces for an event, then the parking event process 200 returns to repeat steps 202 through 218. However, if it is determined at step 218 that the customer does not want to purchase additional parking spaces for an event, then the parking event process 200 then exits at step 219.

FIG. 8 is a flow chart illustrating an example of the operation of the lot direction process 220 on the server 11 that is utilized in parking management system 100 of the present invention, as shown in FIGS. 2-3. In one embodiment, a lot direction action enables the customer to acquire directions from their starting point to the assigned lot location. In an alternative embodiment, the lot direction process 220 determines if alternate roads are to be used because the traffic pattern to the assigned lot location have been altered because of an event. A brief overview of one exemplary process is as follows: 1) the assigned lot is determined; 2), the starting point or home of the customer is determined; 3) determining if any streets around be assigned lot location will be closed; 4) calculating the traffic directions from the starting point to the assigned lot location taking into consideration any street closures; and 5) done.

First at step 221, the lot direction process 220 is initialized. This initialization includes the startup routines and processes embedded in the BIOS of the server 11. The initialization also includes the establishment of data values for particular data structures utilized in the lot direction process 220.

At step 222, the lot direction process 220 waits to receive a lot direction event transaction. Once a lot direction event transaction has been received, the lot direction process 220 then determines the location of the assigned lot, at step 223. At step 224, the starting point or home of the customer is determined. In the preferred embodiment, the customer starting point or home location is acquired from database 12. This data is amongst the data captured during the customer configure process 120. However, in an alternative embodiment, the starting point or home location of the customer can be captured directly from the customer.

At step 225, lot direction process 220 determines if any streets around be assigned lot location will be closed on that date of the parking reservation. In the preferred embodiment, this data is acquired from police, venue management or the light. In an alternative embodiment, this information can be acquired from the parking lot management. At step 226, the traffic directions from the starting point to the assigned lot location is calculated. This calculation takes into consideration any street closures identified above.

At 227, the lot direction process 220 determines if more lot directions are to be processed. If it is determined at step 227 that there are more lot directions are to be processed, then the lot direction process 220 returns to repeat steps 222 through 227. However, if it is determined at step 227 that there are no more lot directions are to be processed, then the lot direction process 220 then exits at step 229.

FIG. 9 is a flow chart illustrating an example of the operation of the parking validation process 240 on the host that is utilized in parking management system 100 of the present invention, as shown in FIGS. 2-3. In one embodiment, a parking validation action occurs at the entrance of a parking lot by scanning the parking pass to validate that the pass is valid for that parking lot and at that date and time. In an alternative embodiment, an attendant may check parking passes while moving through (i.e. on foot or using a vehicle) a parking lot. In the preferred embodiment, a mobile scanner/printer 21 and a stand-alone scanner 22 are used for scanning bar-code passes. A brief overview of one exemplary process is as follows: 1) the parking pass is validated; 2) if the parking pass is invalid, then it is determined if there is a duplicate use of parking passes, that is then documented; 3) if the parking pass was invalidated, then the customer is given an option to purchase a valid parking pass at that time if capacity allows; 4) process the customer parking reservation by allowing the customer to park; 5) update the customer account and prepaid parking transaction for the selected parking lot on database 12; 6) update the number of current slots used for that parking lot on database 12; and 7) done.

First at step 241, the parking validation process 240 is initialized. This initialization includes the startup routines and processes embedded in the BIOS of the server 11. The initialization also includes the establishment of data values for particular data structures utilized in the parking validation process 240.

At step 242, the parking validation process 240 waits to receive a parking validation transaction. Once a parking validation transaction has been received, the parking validation process 240 then validates the parking pass at step 243. The parking pass is validated against information in database 12. If it is determined at step 244 that the parking pass is valid, the parking validation process 240 skip's to step 251. However, if the customer is not valid, then the parking validation process 240 determines if the parking pass is a duplicate at step 245. This can be determined by checking the database 12 for utilization of the parking pass number or other verifying marks. Duplicate use of parking passes can be generated by making printed copies of passes or by transferring information between mobile devices 17-20. Since the information on a mobile device 17-20 is digital, it is quite easily passed between mobile devices 17-20. Since the parking pass is a duplicate, the customer then is given the option to purchase a valid tag if capacity is available, at step 247. The parking validation process 240 performs the customer purchase process 140 defined with regard to FIG. 5A.

At step 251, the parking validation process 240 then processes the customer parking transaction with the appropriate barcode pass associated with the customer account. In a preferred embodiment, this barcode pass is printed. However, in alternative embodiments, this barcode pass can be an image that was sent to the remote device 17-20 for further presentation upon arriving at the preferred parking lot. At step 252, the parking validation process 240 updates the customer account and prepaid parking transaction for the selected parking lot in database 12. At step 253, the database 12 is updated for the selected parking lot with regard to current number of parking slots used.

At step 254, it is determined if the parking validation process 240 is to wait for additional parking validation transactions. If it is determined at step 254 that the parking validation process 240 is to wait for additional parking validation transactions, then the parking validation process 240 returns to repeat steps 242 through 254. However, if it is determined at step 254 that there are no more customer parking validation transactions to be received, then the parking validation process 240 then exits at step 259.

FIG. 10 is a flow chart illustrating an example of the operation of the parking lot management process 260 on the server 11 that is utilized in parking management system 100 of the present invention, as shown in FIGS. 2-3. In one embodiment, a parking lot management action enables management to determine inventory (i.e., current parking slots used and available), configure a parking lot and process any lost passes that it might be discovered in use and the like. A brief overview of one exemplary process is as follows: 1) determines if a lot management function is to occur; 2), if a lot management function is to occur, then for each parking lot there is a determination of the current parking slots used, available slot and enables management to adjust how many current slots are available; 3) determines if an attendant inventory is to be processed; 4) if in an attendant inventory process is to occur, then a connection to each issued handheld device is established and provides an inventory of handheld devices and functionality for each handheld device at each lot; 5) determines is a parking lot is to be configured, which consists of setting fees, fines, violation types and the like for each lot; 6) determine if a customer has lost a pass; 7), if the customer has lost the pass, then it is determined if the loss pass is in use by another party; 8) if it is determined that they loss pass is in use, then the attendant is notified at the lot were be lost past was used; and 9) done.

First at step 261, the parking lot management process 260 is initialized. This initialization includes the startup routines and processes embedded in the BIOS of the server 11. The initialization also includes the establishment of data values for particular data structures utilized in the parking lot management process 260.

At step 262, the parking lot management process 260 waits to receive a management transaction. Once a management transaction has been received, the parking lot management process 260 then determines if a lot management function is to be processed at step 263. If it is determined at step 263 that a lot management function is not to be processed, then the parking lot management process 260 skip to step 268. However, if it is determined that a lot management function is to occur, then for each parking lot there is a determination of the current parking slots used at step 264. At step 265, it is determined for each lot the number of available slots and enables management to adjust how many current slots are available. In some cases, the adjustment of the number of available slot is made as a result of the number of no-shows or over both things.

At step 266, parking slots sales (i.e. online or at site) are discontinued at any lot showing no slots available prior to the start of the event. There may be a showing of no slots available prior to the start of event if customers purchased their parking passes well in advance of the event. At step 267, the parking sales are discontinued for any parking lots supporting an event to start within the cutoff time period. The parking lot management process 260 then returns to step 262 to wait to receive the new management transaction.

At step 268, it is determined if an attendant inventory is to be processed. If it is determined that the management transaction is not an attendant inventory, then the parking lot management process 260 skips to step 271. However, if it is determined at step 268 that the attendant inventory function is to be implemented then the parking lot management process 260 connects to each issued mobile scanner/printer 21 at step 269. The mobile scanner/printer 21 then provides an inventory of each mobile scanner/printer 21 and functionality for each mobile scanner/printer 21 at each lot. The functionality of each mobile scanner/printer 21 may be different depending upon the country, state or city where the parking lot is located. Functionality also may be variable depending upon the capabilities or authorizations provided to the attendant carrying the mobile scanner/printer 21. Other capabilities include, but are not limited to on-site sales, citations, and the like. The parking lot management process 260 then returns to step 262 to wait to receive the new management transaction.

At step 271, the parking lot management process to 260 determines if a lot configuration function is to be performed. If it is determined at step 271 that a lot configuration is not to be performed, then the parking lot management process 260 skips to step 273. However, if it is determined that a lot configuration is to be performed, then the parking lot management process 260 allows configuration of the variables for each lot. The variables for each lot include, but are not limited to, the term total number of parking spaces, prepurchase/event day, fees, fees for parking passes, fines for parking violations and in violation types. The parking lot management process 260 then returns to step 262 to wait to receive the new management transaction.

At step 273, it is determined if a lost past transaction is to be processed. If it is determined at step 273 that a loss pass function is not to be processed, then the parking lot management process 260 skips the step 278. However, if it is determined in step 273 that a loss pass function is to be processed, then the parking lot management process 260 determines if the loss pass in question has been used by another party at step 274. This can be determined by checking the database 12 for utilization of the parking pass number or other verifying marks. Duplicate use of parking passes can be generated by making printed copies of passes or by transferring information between mobile devices 17-20. Since the information on a mobile device 17-20 is digital, it is quite easily passed between mobile devices 17-20.

If it is determined at step 274, that the loss pass is not in use, then the parking lot management process 260 skips to step 276. However, if it is determined at step 274, that the loss pass is in use, then the attendant is notified at the lot when and where the lost pass was used at step 275. The parking lot management process 260 skips to step 277 to give the customer the option to purchase a valid tag to replace the lost/stolen tag. Since the parking pass was used, the customer then pays a predetermined percentage of the actual parking pass fee for a space at the lot utilized. This predetermined percentage of the parking pass fee may range from 0% to event day prices depending upon the transaction history of the customer. In an alternative embodiment, the actual parking pass fee can be adjusted up or down depending upon customer satisfaction, premium rates, how close to capacity the lot is and the like.

In another alternative embodiment, if it is determined at step 270 or that the loss pass was not in use, then step 276 would be skipped and the parking management system 100 would proceed to step 277, and then the customer purchase process 140 would be called. Because this is not a new purchase, the customer purchase process 140 would then enable the customer to receive a reprinted pass.

At step 276, the parking lot management process 260 invalidates the lost pass in database 12. This should prevent the lost/stolen pass from being used at a later time. Since the customer reported the lost/stolen pass and it was not used, the new parking pass fee is set to $0.00.

At step 277, the parking lot management process 260 gives the customer the option to purchase a valid tag at the parking pass fee established in steps 275 and 276 to replace the lost/stolen tag. The option to purchase a valid tag is accomplished by performing the customer purchase process 140 herein defined in detail with regard to FIG. 5A.

At step 278, it is determined if the parking lot management process 260 is to wait for additional management transactions. If it is determined at step 278 that the parking lot management process 260 is to wait for additional management transactions, then the parking lot management process 260 returns to repeat steps 262 through 278. However, if it is determined at step 278 that there are no more management transactions to be received, then the parking lot management process 260 then exits at step 279.

FIG. 11 is a flow chart illustrating an example of the operation of parking violations process 280 on the server 11 that is utilized in parking management system 100 of the present invention, as shown in FIGS. 2-3. In one embodiment, a parking violations action enables a customer to make a payment with regard to a citation or appeal a citation. In an alternative embodiment, the parking violations action enables management to determine if issued citations are over due and manually/automatically send notices of late payments to the recipients of the citations. A brief overview of one exemplary process is as follows: 1) determines if a citation payment function is to occur; 2), if a citation payment function is to occur, then be citation is looked up and any citation fees as well as any late fee is computed; 3) after the citation fees and any late fee or computed, then the customer payment is accepted; 4) after the customer payment is processed and the account updated, and it is determined if the payment is in full, where if the payment is in full, the citation account is closed. However if not come payment in full, a notice of insufficient payment is sent to the customer; 5) if the function is not a citation payment, is determined if the function is a citation appeal; 6) if it is determined that the function violations transaction is a citation appeal, then the appeal is input into the system for later decision and the decision once made it is sent to the customer; 7), if the violations transaction is delivered a citation, then notices of late payment are sent to the customer; and 8) done.

First at step 281, the parking violations process 280 is initialized. This initialization includes the startup routines and processes embedded in the BIOS of the server 11. The initialization also includes the establishment of data values for particular data structures utilized in the parking violations process 280.

At step 282, the parking violations process 280 waits to receive a violation transaction. Once a violation transaction has been received, the parking violations process 280 then determines if a citation payment is to occur, at step 283. If it is determined that a citation payment is not to occur, then the parking violations process 280 skips to step 293. However, if it is determined that a citation payment is to occur, then be citation is looked up at step 284. The citation may be referenced by any number of means including, but not limited to the citation number, be license plate number, the make and model of the car cited for a parking violation and the like. At step 285, the citation fees as well as any late fee are computed.

At step 286, the parking violations process 280 then processes the customer payment. At step 287, the customer's account in database 12 is updated to reflect the customer's most recent payment. It is then determined if the payment is for the full amount of the citation and any late fee at step 288. Where if the payment is in full, the citation account is closed at step 291. The parking violations process 280 then skips to step 298. However, if it is determined that the citation payment is not in full, a notice of insufficient payment is sent to the customer at step 292. This notice will reflect the most recent payment to balance due and any additional late fees. The notice will state the date that the payment is due. The parking violations process 280 then skips to step 298.

At step 293, it is determined if the violations transaction is a citation appeal. If it is determined that the violations transaction is not a citation appeal, then the parking violations process 280 then skips to step 296. However, if it is determined that the violation transaction is a citation appeal, then the appeal is input into the system for later decision at step 294. At step 295, a notice of the decision is sent to the customer. The parking violations process 280 then skips to step 298.

At step 296, the parking violations process 280 then determines if the violations transaction is an overdue citation payment. If it is determined that the violations transaction is an overdue citation payment, then notices of late payment are sent to the customer, at step 297. In one embodiment, the notices may be automatically processed on a daily, weekly, bimonthly or monthly time period. In another embodiment, the late payment may be process after a predetermined amount of time has elapsed from the due date of the citation payment this predetermined amount of time lapse from the due date of the citation payment may be for example, but not limited to, 5, 7, 10, 14, 21, 30 days and the like over due.

At step 298, it is determined if the parking violations process 280 is to wait for additional violation transactions. If it is determined at step 298 that the parking violations process 280 is to wait for additional violation transactions, then the parking violations process 280 returns to repeat steps 292 through 298. However, if it is determined at step 298 that there are no more violation transactions to be received, then the parking violations process 280 then exits at step 299.

FIG. 12 is a flow chart illustrating an example of the operation of the parking lot reports process 300 on the server 11 that is utilized in parking management system 100 of the present invention, as shown in FIGS. 2-3. In one embodiment, a parking lot report action enables management to receive reports with regard to citations, revenue, violators, status of parking lots, and the like. A brief overview of one exemplary process is as follows: 1) determines if a citation report requests has been received and so, provide a citation report by lot#, tag #, time period, attendant, outstanding citations and the like; 2) determine if a revenue report request is received and provide the report by lot number, time period, attendant, citations or the like; 3) determine if a violators report is requested and provide the report including violation types, citations paid, citations unpaid, time period, attendant, lot#, tag #, or the like; 4) determine if a lot report is requested and then provide the report by lot number, lot utilization, tickets scanned per event, multiple use passes and pass IDs, cards sold, current unsold slots, time period, attendant or the like; and 5) done.

First at step 301, the parking lot reports process 300 is initialized. This initialization includes the startup routines and processes embedded in the BIOS of the server 11. The initialization also includes the establishment of data values for particular data structures utilized in the parking lot reports process 300.

At step 302, the parking lot reports process 300 waits to receive a report request. Once a report request has been received, the parking lot reports process 300 then determines if a citation report request has been received at step 303. If it is determined that a citation report request was not received, then the parking lot reports process 300 skips to step 306. However, if it is determined at step 303 that a citation report request has been made, then the parking lot reports process 300 looks up citations by citation #, tag #, car make/model, time period, attendant, outstanding citations and the like, for each lot. The parking lot reports process 300 then creates a citation report by citation #, tag #, car or make/model, time period, attendant, outstanding citations and the like, for each lot. The parking lot reports process 300 then returns to step 302 to wait to receive a new report request.

At step 306, the parking lot reports process 300 then determines if a revenue report request has been received at step 302. If it is determined that a revenue report request was not received, then the parking lot reports process 300 skips to step 311. However, if it is determined at step 306 that a revenue report request has been made, then the parking lot reports process 300 looks up citations by citation #, tag #, car make/model, time period, attendant, outstanding citations and the like, for each lot. The parking lot reports process 300 then creates a revenue report by lot#, time period, attendant, outstanding citations and the like, for each lot. The parking lot reports process 300 then returns to step 302 to wait to receive a new report request.

At step 311, the parking lot reports process 300 determines if a violators report request has been received at step 302. If it is determined that a violators report request was not received, then the parking lot reports process 300 skips to step 313. However, if it is determined at step 311 that a violators report request has been made, then the parking lot reports process 300 looks up citations by citation type, paid citations, unpaid citations, time period, attendant, lot# and the like, for each lot. The parking lot reports process 300 then creates a violators report by citation type, paid citations, unpaid citations, time period, attendant, lot# and the like, for each lot. The parking lot reports process 300 then returns to step 302 to wait to receive a new report request.

At step 313, the parking lot reports process 300 then determines if a lot report request has been received at step 302. If it is determined that a lot report request was not received, then the parking lot reports process 300 skips to step 315. However, if it is determined at step 313 that a lot report request has been made, then the parking lot reports process 300 looks up lot #, lot utilization, tickets scanned per event, multiple use passes and pass IDs, cards sold, current unsold slots, time period, attendant or the like. The parking lot reports process 300 then creates a lot report by lot #, lot utilization, tickets scanned per event, multiple use passes and pass IDs, cards sold, current unsold slots, time period, attendant or the like.

At step 315, it is determined if the parking lot reports process 300 is to wait for additional report requests. If it is determined at step 315 that the parking lot reports process 300 is to wait for additional report requests, then the parking lot reports process 300 returns to repeat steps 302 through 315. However, if it is determined at step 315 that there are no more report requests to be received, then the parking lot reports process 300 then exits at step 319.

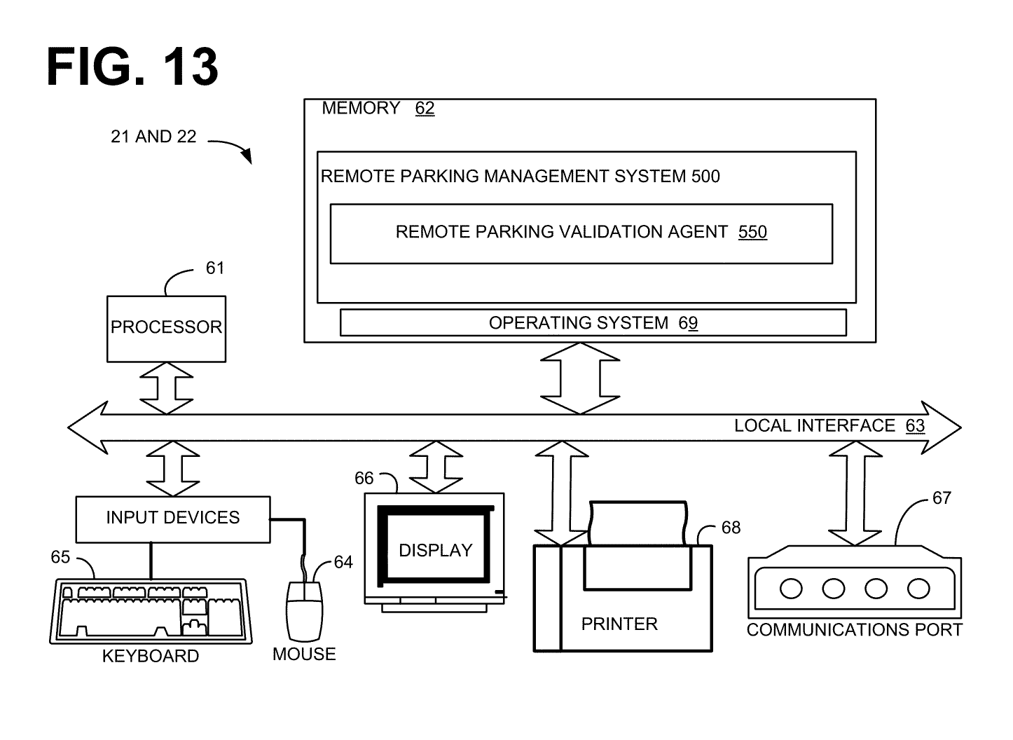

FIG. 13 is a block diagram illustrating an example of a remote device utilizing the remote parking management system 500 for the mobile scanner/printer 21 and a stand-alone scanner 22 of the present invention, as shown in FIG. 1. Mobile scanner/printer 21 and a stand-alone scanner 22 provide access to the parking management system 100 data residing in database 12. The information accessed in database 12 can be provided in the number of different forms including but not limited to ASCII data, WEB page data (i.e. HTML), XML or other type of formatted data. As illustrated, the mobile scanner/printer 21 and a stand-alone scanner 22 include many of the same components as server 11 described with regard to FIG. 2. These components include processor 61, number 62, local interface 63, mouse 64, keyboard/keypad 65, displays 66, communication port 67 and operating system 69. One addition is printer 68. Hereinafter, the mobile scanner/printer 21 and a stand-alone scanner 22 are devices that will be referred to as scanning devices 21 for the sake of brevity.

Located in memory 62 of the scanning device 21 is the remote parking management system 500, which includes, but is not limited to, the remote parking validation agent 550. When the remote parking management system 500 is implemented in software, as is shown in FIG. 13, it can be stored on virtually any computer readable medium for use by or in connection with any computer related system or method.

In an alternative embodiment, where the remote parking management system 500 is implemented in hardware, the remote parking management system 500 can be implemented in the same way as described above with regard to the remote parking management system 500 (FIG. 2).

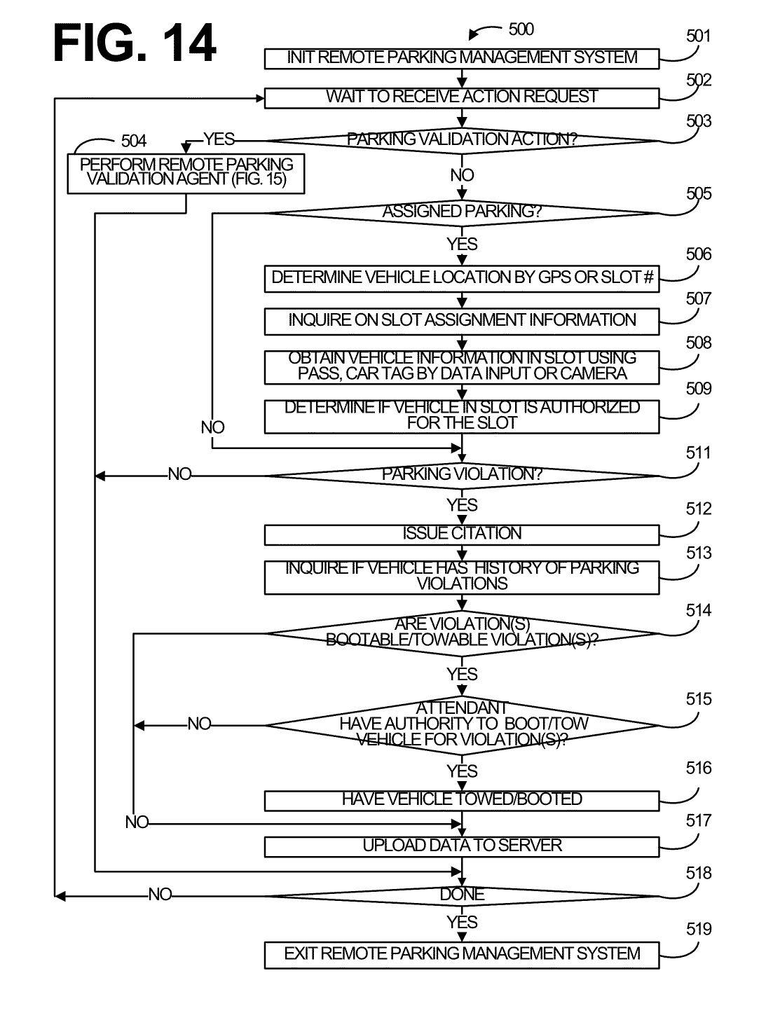

FIG. 14 is a flow chart illustrating an example of the operation of the remote parking management system 500 for the scanning device 21 of the present invention, as shown in FIGS. 1 and 13. The remote parking management system 500 enables an attendant to log into in a database 12 on a server 11 to document and review in real time what is happening with the lot activity. A brief overview of one exemplary process is as follows: 1) determine if a parking validation action was received, and if so, perform the remote parking validation agent; 2) determine if a parking slot is for assigned parking and then validate that the vehicle in the slot is authorized for the parking slot; 3) determine if a parking violation has occurred; 4), if a parking violation has occurred, issued a citation; 5) checked to see if the vehicle has a history of parking violations; 6) determine if the parking violation is a bootable/towable violation; 7) determine if the attendant has the right to boot or tow a vehicle for violations and if so have the vehicle booted/towed; 8) upload the data to the server and 9) done.

First at step 501, the remote parking management system 500 is initialized. This initialization includes the startup routines and processes embedded in the BIOS of the scanning device 21. The initialization also includes the establishment of data values for particular data structures utilized in the remote parking management system 500.

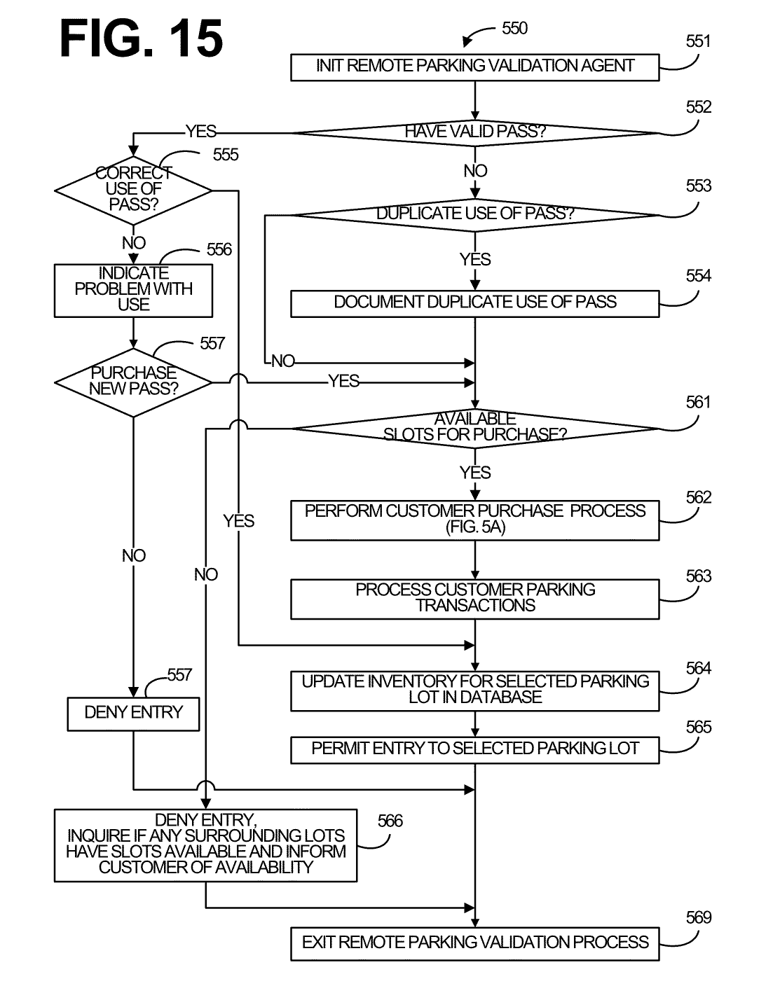

At step 502, the remote parking management system 500 waits to receive an action request. Once an action request has been received, then the remote parking management system 500 determines if a parking validation action was received, at step 503. If it is determined that the request received is not a parking validation action, then the remote parking management system 500 skips to step 505. However, if it is determined that a parking validation action is received, the remote parking management system 500 performs the remote parking validation agent, at step 504. The remote parking validation agent is herein defined in further detail with regard to FIG. 15. After performing the remote parking validation agent, the remote parking management system 500 skips to step 518.

At step 505, the remote parking management system 500 determines if the action request is to verify assigned parking. If it is determined that the action request is to verify assigned parking, then the remote parking management system 500 determines the location of the vehicle by GPS or slot number, at step 506. At step 507, an inquiry is made on the slot assignment information. The vehicle information currently in the slot is obtained by using a parking pass or car tag. In one embodiment, the parking pass or car tag information is acquired through manual data input. In an alternative embodiment, the vehicle information is obtained by using a camera on the scanning device 21 to capture parking pass or car tag information. This information is then processed without manual input by the attendant. At step 509, it is determined if the vehicle in the slot is authorized for the slot.

At step 511, it is determined of a parking violation has occurred. If it is determined at step 511 that no parking violation has occurred, then the remote parking management system 500 then proceeds to step 518. However, if it is determined at step 511 that a parking violation has occurred, then a citation is issued, at step 512. A parking violation might be an unauthorized vehicle in assigned parking slot or some other parking infractions such as, but not limited to, missing or mutilated parking pass, parking outside the parking slot lines, not parking fully within the slot, and the like.

At step 513, an inquiry is made to see if the vehicle being issued a citation has a history of parking violations. At 514, it is determined if the vehicle being issued a citation is a bootable or towable violation. In one embodiment, a single serious violation may create a bootable or towable violation. And another embodiment, a single minor violation may rise to the level to create a bootable or towable violation if the vehicle has a history parking violations. If the violation or violation history does not rise to the level of a bootable or towable violation, then the remote parking management system 500 skips to step 517. However, if it is determined that the violation or violation history does rise to the level of a bootable/towable violation, then it is determined if the attendant has the authority to boot/tow vehicles for violations at step 515. If the attendant does not have the authority to boot/tow vehicles for violations, then the remote parking management system 500 skips to step 517. However, if it is determined that the attendant does have the authority to boot/tow vehicles for violations, then the vehicle is booted/towed, at step 516. Whether to boot or tow a car for violations depends mostly on state law or local ordinance. Some states allow booting a car, but do not allow towing. Other states allow towing, but do not allow booting. In those states where both are allowed, the attendant might have discretion to choose the appropriate penalty for vehicle violations.

At step 517, a data captured on the scanning device 21 is uploaded to server 11.

At step 518, it is determined if the remote parking management system 500 is to wait for additional action requests. If it is determined at step 518 that the remote parking management system 500 is to wait for additional action requests, then the remote parking management system 500 returns to repeat steps 502 through 518. However, if it is determined at step 518 that there are no more report requests to be received, then the remote parking management system 500 then exits at step 519.

FIG. 15 is a flow chart illustrating an example of the operation of the remote parking validation agent 550 for the remote parking management system 500 on the scanning device 21 of the present invention, as shown in FIGS. 13-14. In one embodiment, a remote parking validation action occurs at the entrance of a parking lot by scanning the parking pass to validate that the pass is valid for that parking lot and at that date and time. In an alternative embodiment, an attendant may check parking passes while moving through (i.e. on foot or using a vehicle) a parking lot. In the preferred embodiment, a mobile scanner/printer 21 and a stand-alone scanner 22 are used for scanning bar-code passes. A brief overview of one exemplary process is as follows: 1) the parking pass is validated; 2) if the parking pass is valid, and it is then determined if the pass is being used correctly (i.e. at the correct lot, for the correct event, at correct time, and the like); 3) if the parking pass is used at the correct event at the correct time and at the correct lot, then the customer is permitted entry, otherwise the customer is invited to purchase another parking is invited to purchase a new parking pass through that lot, event and time; 4) if the parking pass is invalid, then it is determined if there is a duplicate use of parking passes, that is then documented; 5) if the parking pass was invalid, then verify that there are available slots for purchase; 6) if the parking pass was invalid and slots are not available for purchase, denying entry and check if surrounding lots have slots available, and then inform the customer; 7) if the parking pass was invalid and slots are available for purchase, the customer is given an option to purchase a valid parking pass at that time; 8) process the customer parking reservation by allowing the customer to park; 9) update the customer account and prepaid parking transaction for the selected parking lot on database 12; 10) update the number of current slots used for that parking lot on database 12; and 11) done.

At step 552, the remote parking validation agent 550 validates the parking pass. The parking pass is validated against information in database 12. If it is determined at step 552 that the parking pass is valid, the remote parking validation agent 550 proceeds to step 555. However, if the parking pass is not valid, then the remote parking validation agent 550 determines if the parking pass is a duplicate at step 553. This can be determined by checking the database 12 for utilization of the parking pass number or other verifying marks. Duplicate use of parking passes can be generated by making printed copies of passes or by transferring information between mobile devices 17-20. Since the information on a mobile device 17-20 is digital, it is quite easily passed between mobile devices 17-20. Since the parking pass is a duplicate, the customer then is given the option to purchase a valid tag. The remote parking validation agent 550 then proceeds to step 561.

At step 555, the remote parking validation agent 550 determines if the parking pass is used at the correct event, at the correct time and at the correct lot, then the remote parking validation agent 550 skips to step 564 to permit entry. Otherwise, the customer is informed of the improper use of a valid pass invited to purchase another parking is invited to purchase a new parking pass for that lot, event and time, at step 557. If the customer agrees to purchase a new parking pass for that lot, event and time, then the remote parking validation agent 550 skips to step 561. However, if the customer does not agree to purchase a new pass for that lot, event and time, then the customer is denied entry to the lot, at step 557. The remote parking validation agent 550 then proceeds to step 569 to exit.

At step 561, the remote parking validation agent 550 determines if there are slots available for purchase. If it is determined that there are no slots available for purchase, then the remote parking validation agent 550 proceeds to step 566. However, if it is determined that there are more slots available for purchase, then the remote parking validation agent 550, at step 562, performs the customer purchase process 140 defined with regard to FIG. 5A.

At step 563, the remote parking validation agent 550 then processes the customer parking transaction and provides the appropriate barcode pass associated with the customer account. In a preferred embodiment, this barcode pass is printed. However, in alternative embodiments, this barcode pass can be an image that was sent to the remote device 17-20 for further presentation upon arriving at the preferred parking lot. In still another embodiment, the barcode pass may utilize a different implementation such as a credit card number or by license plate recognition. The customer is then permitted to enter the parking lot. At step 563, the remote parking validation agent 550 updates the database 12 for the selected parking lot with regard to current number of parking slots used. The remote parking validation agent 550 skips to step 569.

At step 565, the remote parking validation agent 550 indicates that the vehicle is to be denied entry and inquirers if any of the surrounding lots have slots available and informs the customer of slot availability.

At step 569, the remote parking validation agent 550 then exits.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

While the invention has been described with reference to preferred and example embodiments, it will be understood by those skilled in the art that a variety of modifications, additions and deletions are within the scope of the invention, as defined by the following claims.

What is claimed is:

1. A method for providing a parking reservation embodied in a computer program product for execution on an instruction processing system, comprising a tangible storage medium readable by the instruction processing system is storing instructions for execution by the instruction processing system for performing the method comprising:
enabling a customer to purchases a bar-coded pass online for an event;
collecting payment for the bar-coded pass;
issuing the bar-coded pass to the customer;
updating a current available parking slots inventory for a selected parking lot in the tangible storage medium;
validating the bar-coded pass by scanning the bar-coded pass to verify that the bar-coded pass is good.

2. The method of claim 1, further comprising:
receiving notification that the customer has lost a valid bar-coded pass;
verifying that the bar-coded pass has not been used already; and
reissuing a new bar-coded pass if the bar-coded pass has not already been used.

3. The method of claim 2, further comprising:
requiring the customer to purchase the new bar-coded pass if the bar-coded pass has already been used; and
notifying an attendant at the selected parking lot to locate a vehicle using the lost bar-coded pass.

4. The method of claim 4, further comprising:
issuing a citation to the vehicle using the lost bar-coded pass.

5. The method of claim 1, wherein the bar-coded pass further comprises:
an electronic form that can be printed by the customer.

6. The method of claim 1, wherein the bar-coded pass further comprises:
an electronic form that can displayed on a mobile device.

7. The method of claim 1, wherein the bar-coded pass includes a map to selected parking lot.

8. The method of claim 7, further comprising:
determining a selected parking lot location; and
determining a starting point for the customer at a time of the event.

9. The method of claim 7, further comprising:
determining if there will be altered traffic patterns during the time of the event; and
illustrating altered traffic patterns on the map to selected parking lot.

10. The method of claim 1, further comprising:
determining the selected lot by the location of the event.

11. The method of claim 1, further comprising:
determining if the event is a single or multiple occurrence.

12. The method of claim 1, further comprising:
determining if a third party is managing the distribution of the bar-coded pass.

13. A method for providing a long-term parking reservation embodied in a computer program product for execution on an instruction processing system, comprising a tangible storage medium readable by the instruction processing system is storing instructions for execution by the instruction processing system for performing the method comprising:
determining a selected parking lot;
determining the parking term period;
collecting payment for the long-term parking reservation;
issuing a bar-coded pass for the long-term parking reservation to the customer if there is a slot space available in the selected parking lot and the payment is successful; and
updating a current available parking slots inventory for a selected parking lot in the tangible storage medium if the bar-coded pass is issued to the customer.

14. The method of claim 13, further comprising:
placing the customer on a wait list for the selected parking lot if there a slot space is not available in the selected parking lot.

15. The method of claim 13, further comprising:
determining if any parking violation fees are outstanding if the long-term reservation is a renewing of a current long-term parking reservation.

16. The method of claim 15, further comprising:
determining if any of the parking violations would cause a termination of the long-term parking reservation.

17. The method of claim 16, further comprising:
sending a customer notification of the parking violation fees and the reasons for termination of the long-term parking reservation.

18. A method for providing a remote validation of a bar-coded event pass embodied in a computer program product for execution on an instruction processing system, comprising a tangible storage medium readable by the instruction processing system is storing instructions for execution by the instruction processing system for performing the method comprising:
scanning the bar-coded event pass with a scanner;
determining if the bar-coded event pass is valid;
permitting entry to a event if the bar-coded event pass is valid; and
denying entry to the event if the bar-coded event pass is invalid.

19. The method of claim 18, further comprising:
determining if there are slots available for purchase of a substitute bar-coded event pass if the bar-coded event pass is invalid.

20. The method of claim 19, further comprising:
updating a current available event slots inventory for the event in the tangible storage medium if the bar-coded event pass is valid.

21. The method of claim 18, wherein the bar-coded event pass is a bar-coded parking pass and further comprises:
determining if the bar-coded parking pass is assigned a reserved slot.

22. The method of claim 21, further comprising:
determining a location of a vehicle in a reserved slot; and
determining if the vehicle in the reserved slot is authorized by the bar-coded parking pass.

23. The method of claim 21, further comprising:
obtaining information on the vehicle in the reserved slot using a bar-coded parking pass.

24. The method of claim 21, wherein the scanner is a handheld scanner and the location of the vehicle is determined by a GPS unit in the handheld scanner.

25. A method for issuing a citation to a parking violation of vehicle embodied in a computer program product for execution on an instruction processing system, comprising a tangible storage medium readable by the instruction processing system is storing instructions for execution by the instruction processing system for performing the method comprising:
scanning a bar-coded parking pass of the vehicle in question;
inquiring if the vehicle has a history of parking violations;
determining if the bar-coded parking pass is valid; and
issuing the citation if the bar-coded parking pass is invalid.

26. The method of claim 25, further comprising:
determining if the citation dictates escalated action.

27. The method of claim 25, wherein the escalated action is placing a boot on the vehicle.

28. The method of claim 25, wherein the escalated action is towing the vehicle.

29. The method of claim 25, further comprising:
determining if the attendant has authority to implement the escalated action.
